(19) United States
(12) Patent Application Publication
(10) Pub. No.: US 2008/0281526 A1
(43) Pub. Date: Nov. 13, 2008

(54) Methods For Molecular Toxicology Modeling

(76) Inventors: James C. Diggans, Gaithersburg, MD (US); Michael Elashoff, Gaithersburg, MD (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 10/580,423

(22) PCT Filed: Nov. 24, 2004
(86) PCT No.: PCT/US04/39593

§ 371 Date: Feb. 6, 2008

Related U.S. Application Data
(60) Provisional application No. 60/554,981, filed on Mar. 22, 2004.
(60) Provisional application No. 60/613,831, filed on Sep. 29, 2004.

(51) Int. Cl. G06F 19/00

(52) U.S. Cl. 702/19

(57) ABSTRACT

The present invention is based on methods of predicting toxicity of test agents and methods of generating toxicity prediction models using algorithms for analyzing quantitative gene expression information. The invention also includes computer systems comprising the toxicity prediction models, as well as methods of using the computer systems by remote users for determining the toxicity of test agents.

### RELATED APPLICATIONS

This application claims the benefit of U.S. Provisional Application Ser. No. 60/554,981, filed Mar. 22, 2004 and U.S. Provisional Application Ser. No. 60/613,831, filed Sep. 29, 2004, both of which are herein incorporated by reference in their entirety for all purposes. This application also claims priority to PCT Application No. PCT/US03/37556, filed Nov. 24, 2003, which is herein incorporated by reference in its entirety for all purposes.

### SEQUENCE LISTING SUBMISSION ON COMPACT DISC

The Sequence Listing submitted concurrently herewith on compact disc under 37 C.F.R. §§1.821(c) and 1.821(e) is herein incorporated by reference in its entirety. Four copies of the Sequence Listing, one on each of four compact discs are provided. Copy 1, Copy 2 and Copy 3 are identical. Copies 1, 2 and 3 are also identical to the CRF. Each electronic copy of the Sequence Listing was created on Nov. 22, 2004 with a file size of 2398 KB. The file names are as follows: Copy 1—gene logic 5133-wo.txt; Copy 2—gene logic 5133-wo.txt; Copy 3—gene logic 5133-wo.txt; CRF—gene logic 5133-wo.txt.

### BACKGROUND OF THE INVENTION

The need for methods of assessing the toxic impact of a compound, pharmaceutical agent or environmental pollutant on a cell or living organism has led to the development of procedures which utilize living organisms as biological monitors. The simplest and most convenient of these systems utilize unicellular microorganisms such as yeast and bacteria, since they are the most easily maintained and manipulated. In addition, unicellular screening systems often use easily detectable changes in phenotype to monitor the effect of test compounds on the cell. Unicellular organisms, however, are inadequate models for estimating the potential effects of many compounds on complex multicellular animals, as they do not have the ability to carry out biotransformations.

The biotransformation of chemical compounds by multicellular organisms is a significant factor in determining the overall toxicity of agents to which they are exposed. Accordingly, multicellular screening systems may be preferred or required to detect the toxic effects of compounds. The use of multicellular organisms as toxicology screening tools has been significantly hampered, however, by the lack of convenient screening mechanisms or endpoints, such as those available in yeast or bacterial systems. Additionally, certain previous attempts to produce toxicology prediction systems have failed to provide the necessary modeling data and statistical information to accurately predict toxic responses (e.g., WO 00/12760, WO 00/47761, WO 00/63435, WO 01/32928, and WO 01/38579).

The pharmaceutical industry spends significant resources to ensure that therapeutic compounds of interest are not toxic to human beings. This process is lengthy as well as expensive and involves testing in a series of organisms starting with rats and progressing to dogs or non-human primates. Moreover, modeling methods for designing candidate pharmaceuticals and their synthesis in nucleic acid, peptide or organic compound libraries has increased the need for inexpensive, fast and accurate methods to predict toxic responses. Toxicity modeling methods based on nucleic acid hybridization platforms would allow the use biological samples from compound-exposed animal or cell culture samples, such as rats or rat hepatocyte cell cultures, to detect human organ toxicity much earlier than has been possible to date.

### SUMMARY OF THE INVENTION

The present invention is based, in part, on the elucidation of the global changes in gene expression in animal tissues or cells, such as liver or kidney tissue or cells, exposed to known toxins, in particular hepatotoxins or renal toxins, as compared to unexposed tissues or cells, as well as the identification of individual genes that are differentially expressed upon toxin exposure.

In various aspects, the invention includes methods of predicting at least one toxic effect of a test agent by comparing gene expression information from agent-exposed samples to a database of gene expression information from toxin-exposed and control samples (vehicle-exposed samples or samples exposed to a non-toxic compound or low levels of a toxic compound). These methods comprise providing or generating quantitative gene expression information from the samples, converting the gene expression information to matrices of fold-change values by a robust multi-array average (RMA) algorithm, generating a gene regulation score for each gene that is differentially expressed upon exposure to the test agent by a partial least squares (PLS) algorithm, and calculating a sample prediction score for the test agent. This sample prediction score is then compared to a reference prediction score for one or more toxicity models. If the sample prediction score is equal to or greater than the reference prediction score, the test agent can be predicted to have at least one toxic effect or to produce at least one pathology corresponding to the toxicity model to which the test agent's prediction score is compared.

In various aspects, the invention includes methods of creating a toxicology model. These methods comprise providing or generating quantitative nucleic acid hybridization data for a plurality of genes from at least one cell or tissue sample exposed to a toxin and at least one cell or tissue sample exposed to the toxin vehicle, converting the hybridization data from at least one gene to a gene expression measure, such as fold-change value, by a robust multi-array average (RMA) algorithm, generating a gene regulation score from a gene expression measure for at least one gene by a partial least squares (PLS) algorithm, and generating a toxicity reference prediction score for the toxin, thereby creating a toxicology model.

In other aspects, the invention includes a computer system comprising a computer readable medium containing a toxicity model for predicting the toxicity of a test agent and software that allows a user to predict at least one toxic effect of a test agent by comparing a sample prediction score for the test agent to a toxicity reference prediction score for the toxicity model.

In further aspects of the invention, the gene expression information from test agent-exposed tissues or cells may be prepared as text or binary files, such as CEL files, and transmitted via the Internet for analysis and comparisons to the toxicity models stored on a remote, central server. After processing, the user that sent the text files receives a report indicating the toxicity or non-toxicity of the test agent.

In other aspects of the invention, the user may download one or more toxicity models from the remote, central server, as well as software for manipulating the user's data and the toxicity models, to a local server. Gene expression information from test agent-exposed tissues or cells may then be prepared as text files, such as CEL files, and analyzed and compared at the user's site to the toxicity models stored on the local server. After processing, the software generates a report indicating the toxicity or non-toxicity of the test agent.

### TABLES

Table 1: Table 1 provides the GLGC identifier (fragment names from Table 2) in relation to the SEQ ID NO. and GenBank Accession number for each of the gene fragments listed in Table 2 (all of which are herein incorporated by reference and replication in the attached sequence listing). The gene names and Unigene cluster titles are also included.

Table 2: Table 2 presents the PLS scores (weighted gene index scores) from an exemplary kidney general toxicity model.

### DETAILED DESCRIPTION

### Definitions

As used herein, “nucleic acid hybridization data” refers to any data derived from the hybridization of a sample of nucleic acids to a one or more of a series of reference nucleic acids. Such reference nucleic acids may be in the form of probes on a microarray or set of beads or may be in the form of primers that are used in polymerization reactions, such as PCR amplification, to detect hybridization of the primers to the sample nucleic acids. Nucleic hybridization data may be in the form of numerical representations of the hybridization and may be derived from quantitative, semi-quantitative or non-quantitative analysis techniques or technology platforms. Nucleic acid hybridization data includes, but is not limited to gene expression data. The data may be in any form, including florescence data or measurements of florescence probe intensities from a microarray or other hybridization technology platform. The nucleic acid hybridization data may be raw data or may be normalized to correct for, or take into account, background or raw noise values, including background generated by microarray high/low intensity spots, scratches, high regional or overall background and raw noise generated by scanner electrical noise and sample quality fluctuation.

As used herein, “cell or tissue samples” refers to one or more samples comprising cell or tissue from an animal or other organism, including laboratory animals such as rats or mice. The cell or tissue sample may comprise a mixed population of cells or tissues or may be substantially a single cell or tissue type, such as hepatocytes or liver tissue. Cell or tissue samples as used herein may also be in vitro grown cells or tissue, such as primary cell cultures, immortalized cell cultures, cultured hepatocytes, cultured liver tissue, etc. Cells or tissue may be derived from any organ, including but not limited to, liver, kidney, cardiac, muscle (skeletal or cardiac) or brain.

As used herein, “test agent” refers to an agent, compound or composition that is being tested or analyzed in a method of the invention. For instance, a test agent may be a pharmaceutical candidate for which toxicology data is desired.

As used herein, “test agent vehicle” refers to the diluent or carrier in which the test agent is dissolved, suspended in or administered in, to an animal, organism or cells.

As used herein, “toxin vehicle” refers to the diluent or carrier in which a toxin is dissolved, suspended in or administered in, to an animal, organism or cells.

As used herein, a “gene expression measure” refers to any numerical representation of the expression level of a gene or gene fragment in a cell or tissue sample. A “gene expression measure” includes, but is not limited to, a fold-change value.

As used herein, “at least one gene” refers to a nucleic acid molecule detected by the methods of the invention in a sample. The term “gene” as used herein, includes fully characterized open reading frames and the encoded mRNA as well as fragments of expressed RNA that are detectable by any hybridization method in the cell or tissue samples assayed as described herein. For instance, a “gene” includes any species of nucleic acid that is detectable by hybridization to a probe in a microarray, such as the “genes” of Table 1. As used herein, at least one gene includes a “plurality of genes.”

As used herein, “fold-change value” refers to a numerical representation of the expression level of a gene, genes or gene fragments between experimental paradigms, such as a test or treated cell or tissue sample, compared to any standard or control. For instance, a fold-change value may be presented as microarray-derived florescence or probe intensities for a gene or genes from a test cell or tissue sample compared to a control, such as an unexposed cell or tissue sample or a vehicle-exposed cell or tissue sample. An RMA fold-change value as described herein is a non-limiting example of a fold-change value calculated by methods of the invention.

As used herein, “gene regulation score” refers to a quantitative measure of gene expression for a gene or gene fragment as derived from a weighted index score or PLS score for each gene and the fold-change value from treated vs. control samples.

As used herein, “sample prediction score” refers to a numerical score produced via methods of the invention as herein described. For instance, a “sample prediction score” may be calculated using the PLS weight or PLS score for at least one gene in a gene expression profile generated from the sample and the RMA fold-change value for that same gene. A “sample prediction score” is derived from summing the individual gene regulation scores calculated for a given sample.

As used herein, “toxicity reference prediction score” refers to a numerical score generated from a toxicity model that can be used as a cut-off score to predict at least one toxic effect of a test agent. For instance, a sample prediction score can be compared to a toxicity reference prediction score to determine if the sample score is above or below the toxicity reference prediction score. Sample prediction scores falling below the value of a toxicity reference prediction score are scored as not exhibiting at least one toxic effect and sample prediction scores above the value if a toxicity reference prediction score are scored as exhibiting at least one toxic effect.

As used herein, a log scale linear additive model includes any log-liner model such as log scale robust multi-array average or RMA (Irizarry et al., Nucleic Acids Research 31(4) e15 (2003).

As used herein, “remote connection” refers to a connection to a server by a means other than a direct hard-wired connection. This term includes, but is not limited to, connection to a server through a dial-up line, broadband connection, Wi-Fi connection, or through the Internet.

As used herein, a “CEL file” refers to a file that contains the average probe intensities associated with a coordinate position, cell or feature on a microarray (such information provided by the CDF or ILQ file). See Affymetrix GeneChip® Expression Analysis Technical Manual, which is herein

As used herein, a “gene expression profile” comprises any quantitative representation of the expression of at least one mRNA species in a cell sample or population and includes profiles made by various methods such as differential display, PCR, microarray and other hybridization analysis, etc.

Methods of Generating Toxicity Models

To evaluate and identify gene expression changes that are predictive of toxicity, studies using selected compounds with well characterized toxicity may be used to build a model or database of the present invention. Methods of the present invention include an RMA/PLS method (analysis of raw gene expression data by the robust multi-array average algorithm, with evaluation of predictive ability by the partial least squares algorithm) to create models and databases for predicting toxicity.

In general, cell and tissue samples are analyzed after exposure to compounds known to exhibit at least one toxic effect. Low doses of these compounds, or the vehicles in which they were prepared, are used as negative controls. Compounds that are known not to exhibit at least one toxic effect may also be used as negative controls.

In the present invention, a toxicity study or “tox study” comprises a set of cell or tissue samples that have been exposed to one or more toxins and may include matched samples exposed to the toxin vehicle or a low, non-toxic, dose of the toxin. As described below, the cell or tissue samples may be exposed to the toxin and control treatments in vivo or in vitro. In some studies, toxin and control exposure to the cell or tissue samples may take place by administering an appropriate dose to an animal model, such as a laboratory rat. In some studies, toxin and control exposure to the cell or tissue samples may take place by administering an appropriate dose to a sample of in vitro grown cells or tissue, such as primary rat or human hepatocytes. These samples are typically organized into cohorts by test compound, time (for instance, time from initial test compound dosage to time at which rats are sacrificed), and dose (amount of test compound administered). All cohorts in a tox study typically share the same vehicle control. For example, a cohort may be a set of samples from rats that were treated with acyclovir for 6 hours at a high dosage (100 mg/kg). A time-matched vehicle cohort is a set of samples that serve as controls for treated animals within a tox study, e.g., for 6-hour acyclovir-treated high dose samples the time-matched vehicle cohort would be the 6-hour vehicle-treated samples with that study.

A toxicity database or “tox database” is a set of tox studies that alone or in combination comprise a reference database. For instance, a reference database may include data from rat tissue and cell samples from rats that were treated with different test compounds at different dosages and exposed to the test compounds for varying lengths of time.

RMA, or robust multi-array average, is an algorithm that converts raw fluorescence intensities, such as those derived from hybridization of sample nucleic acids to an Affymetrix GeneChip® microarray, into expression values, one value for each gene fragment on a chip (Irizarry et al. (2003), Nucleic Acids Res. 31(4):e15, 8 pp.; and Irizarry et al. (2003) “Exploration, normalization, and summaries of high density oligonucleotide array probe level data,” Biostatistics 4(2): 249-264). RMA produces values on a log 2 scale, typically between 4 and 12, for genes that are expressed significantly above or below control levels. These RMA values can be positive or negative and are centered around zero for a fold-change of about 1. A matrix of gene expression values generated by RMA can be subjected to PLS to produce a model for prediction of toxic responses, e.g., a model for predicting liver or kidney toxicity. In a preferred embodiment, the model is validated by techniques known to those skilled in the art. Preferably, a cross-validation technique is used. In such a technique, the data is randomly broken into training and test sets several times until model success rate is determined. Most preferably, such technique uses ⅔/⅓ cross-validation, where ⅓ of the data is dropped and the other ⅔ is used to rebuild the model.

PLS, or Partial Least Squares, is a modeling algorithm that takes as inputs a matrix of predictors and a vector of supervised scores to generate a set of prediction weights for each of the input predictors (Nguyen et al. (2002), Bioinformatics 18:39-50). These prediction weights are then used to calculate a gene regulation score to indicate the ability of each analyzed gene to predict a toxic response. As described in the examples, the gene regulation scores may then be used to calculate a toxicity reference prediction score.

From the nucleic acid hybridization data, a gene expression measure is calculated for one or more genes whose level of expression is detected in the nucleic acid hybridization value. As described above, the gene expression measure may comprise an RMA fold-change value. The toxicity reference score=ΣwᵢR^{FC}^{ᵢ}. “i” is the index number for each gene in a gene expression profile to be evaluated. “wᵢ” is the PLS weight (or PLS score, see Table 2) for each gene. “R^{FC}^{ᵢ}” is the RMA fold-change value for the i^{th} gene, as determined from a normalized RMA matrix of gene expression data from the sample (described above). The PLS weight multiplied by the RMA fold-change value gives a gene regulation score for each gene, and the regulation scores for all the individual genes are added to give a toxicity reference prediction score for a sample or cohort of sample. A toxicity reference prediction score can be calculated from at least one gene regulation score, or at least about 5, 10, 25, 50, 100, 500 or about 1,000 or more gene regulation scores.

In one embodiment of the invention, a toxicology or toxicity model of the invention is prepared or created by the steps of (a) providing nucleic acid hybridization data for a plurality of genes from at least one cell or tissue sample exposed to a toxin and at least one cell or tissue sample exposed to the toxin vehicle; (b) converting the hybridization data from at least one gene to a gene expression measure; (c) generating a gene regulation score from gene expression measure for said at least one gene; and (d) generating a toxicity reference prediction score for the toxin, thereby creating a toxicology model. The gene expression measure may be a gene fold-change value calculated by a log scale linear additive model such as RMA and the toxicity reference prediction score may be generated with PLS. The toxicity reference prediction score may then be added to a toxicity model or database and be used to predict at least one toxic effect of an unknown test agent or compound.

In another preferred embodiment, the model is validated by techniques known to those skilled in the art. Preferably, a cross-validation technique is used. In such a technique, the data is randomly broken into training and test sets several times until an acceptable model success rate is determined. Most preferably, such technique uses ⅔/⅓ cross-validation, where ⅓ of the data is dropped and the other ⅔ is used to rebuild the model.

### Methods of Predicting Toxic Effects

The gene regulation scores and toxicity prediction scores derived from cell or tissue samples exposed to toxins may be used to predict at least one toxic effect, including the hepatotoxicity, renal toxicity or other tissue toxicity of a test or unknown agent or compound. The gene regulation scores and toxicity prediction scores from cell or tissue samples exposed to toxins may also be used to predict the ability of a test agent or compound to induce a tissue pathology, such as liver necrosis, in a sample. The toxicology prediction methods of the invention are limited only by the availability of the appropriate toxicology model and toxicology prediction scores. For instance, the prediction methods of a given system, such as a computer system or database of the invention, can be expanded simply by running new toxicology studies and models of the invention using additional toxins or specific tissue pathology inducing agents and the appropriate cell or tissue samples.

As used, herein, at least one toxic effect includes, but is not limited to, a detrimental change in the physiological status of a cell or organism. The response may be, but is not required to be, associated with a particular pathology, such as tissue necrosis. Accordingly, the toxic effect includes effects at the molecular and cellular level. Hepatotoxicity, for instance, is an effect as used herein and includes but is not limited to the pathologies of: cholestasis, genotoxicity/carcinogenesis, hepatitis, human-specific toxicity, induction of liver enlargement, steatosis, macrovesicular steatosis, microvesicular steatosis, necrosis, non-1-genotoxic/non-carcinogenic toxicity, peroxisome proliferation, rat non-genotoxic toxicity, and general hepatotoxicity.

In general, assays to predict the toxicity of a test agent (or compound or multi-component composition) comprise the steps of exposing a cell or tissue sample or population of cell or tissue samples to the test agent or compound, providing nucleic acid hybridization data for at least one gene from the test agent exposed cell or tissue sample(s), by, for instance, assaying or measuring the level of relative or absolute gene expression of one or more of the genes, such as one or more of the genes in Table 2, calculating a sample prediction score and comparing the sample prediction score to one or more toxicology reference scores (see Example 1).

Sample prediction scores may be calculated as follows: sample prediction score=1 wᵢR^{FC}^{ᵢ}. “i” is the index number for each gene in a gene expression profile to be evaluated. “wᵢ” is the PLS weight (or PLS score) for each gene derived from a toxicity model. “R^{FC}^{ᵢ}” is the RMA fold-change value for the i^{th} gene, as determined from a normalized RMA matrix of gene expression data from the sample (described above). The PLS weight from a given model multiplied by the RMA fold-change value gives a gene regulation score for each gene, and the regulation scores for all the individual genes are added to give a prediction score for the sample.

Nucleic acid hybridization data may include any measurement of the hybridization, including gene expression levels, of sample nucleic acids to probes corresponding to about (or at least) 2, 3, 4, 5, 6, 7, 8, 9, 10, 15, 20, 25, 30, 50, 75, 100, 200, 500, 1000 or more genes, or ranges of these numbers, such as about 2-10, about 10-20, about 20-50, about 50-100, about 100-200, about 200-500 or about 500-1000 genes. Nucleic acid hybridization data for toxicity prediction may also include the measurement of nearly all the genes in a toxicity model. “Nearly all” the genes may be considered to mean at least 80% of the genes in any one toxicity model.

The methods of the invention to predict at least one toxic effect of a test agent or compound may be practiced by one individual or at one location, or may be practiced by more than one individual or at more than one location. For instance, methods of the invention include steps wherein the exposure of a test agent or compound to a cell or tissue sample(s) is accomplished in one location, nucleic acid processing and the generation of nucleic acid hybridization data takes place at another location and gene regulation and sample prediction scores calculated or generated at another location.

In another embodiment of the invention, cell or tissue samples are exposed to a test agent or compound by administering the agent to laboratory rats and nucleic acids are processed from selected tissues and hybridized to a microarray to produce nucleic acid hybridization data. The nucleic acid hybridization data is then sent to a remote server comprising a toxicology reference database and software that enables generation of individual gene regulation scores and one or more sample prediction scores from the nucleic acid hybridization data. The software may also enable a user to pre-select specific toxicology models and to compare the generated sample prediction scores to one or more toxicology reference scores contained within a database of such scores. The user may then generate or order an appropriate output product(s) that presents or represents the results of the data analysis, generation of gene regulation scores, sample prediction scores and/or comparisons to one or more toxicology reference scores.

Data, including nucleic acid hybridization data, may be transmitted to a server via any means available, including a secure direct dial-up or a secure or unsecured Internet connection. Toxicology prediction reports or any result of the methods herein may also be transmitted via these same mechanisms. For instance, a first user may transmit nucleic acid hybridization data to a remote server via a secure password protected Internet link and then request transmission of a toxicology report from the server via that same Internet link.

Data transmitted by a remote user of a toxicity database or model may be raw, un-normalized data or may be normalized from various background parameters before transmission. For instance, data from a microarray may be normalized for various chip and background parameters such as those described above, before transmission. The data may be in any form, as long as the data can be recognized and properly formatted by available software or the software provided as part of a database or computer system. For instance, microarray data may be provided and transmitted in a .cel file or any other common data files produced from the analysis of microarray based hybridization on commercially available technology platforms (see, for instance, the Affymetrix GeneChip® Expression Analysis Technical Manual available at www.affymetrix.com). Such files may or may not be annotated with various information, for instance, but not limited to, information related to the customer or remote user, cell or tissue sample data or information, hybridization technology or platform on which the data was generated and/or test agent data or information.

Once data is received, the nucleic acid hybridization data may be screened for database compatibility by any available means. In one embodiment, commonly available data quality control metrics can be applied. For instance, outlier analysis methods or techniques may be utilized to identify samples incompatible with the database, for instance, samples exhibiting erroneous florescence values from control probes which are common between the data and the database or toxicity model. In addition, various data QC metrics can be applied, including one or more disclosed in PCT/US03/24160, filed Aug. 1, 2003, which claims priority to U.S. provisional application 60/399,727.

### Cell or Tissue Sample Preparation

As described above, the cell population that is exposed to the test agent, compound or composition may be exposed in vitro or in vivo. For instance, cultured or freshly isolated liver cells, in particular rat hepatocytes, may be exposed to the agent under standard laboratory and cell culture conditions. In another assay format, in vivo exposure may be accomplished by administration of the agent to a living animal, for instance a laboratory rat.

Procedures for designing and conducting toxicity tests in in vitro and in vivo systems are well known, and are described in many texts on the subject, such as Loomis et al., Loomis's Essentials of Toxicology, 4th Ed., Academic Press, New York, 1996; Echobichon, The Basics of Toxicity Testing, CRC Press, Boca Raton, 1992; Frazier, editor, In Vitro Toxicity Testing, Marcel Dekker, New York, 1992; and the like.

In in vitro toxicity testing, two groups of test organisms are usually employed. One group serves as a control, and the other group receives the test compound in a single dose (for acute toxicity tests) or a regimen of doses (for prolonged or chronic toxicity tests). Because, in some cases, the extraction of tissue as called for in the methods of the invention requires sacrificing the test animal, both the control group and the group receiving compound must be large enough to permit removal of animals for sampling tissues, if it is desired to observe the dynamics of gene expression through the duration of an experiment.

In setting up a toxicity study, extensive guidance is provided in the literature for selecting the appropriate test organism for the compound being tested, route of administration. dose ranges, and the like. Water or physiological saline (0.9% NaCl in water) is the solute of choice for the test compound since these solvents permit administration by a variety of routes. When this is not possible because of solubility limitations, vegetable oils such as corn oil or organic solvents such as propylene glycol may be used.

Regardless of the route of administration, the volume required to administer a given dose is limited by the size of the animal that is used. It is desirable to keep the volume of each dose uniform within and between groups of animals. When rats or mice are used, the volume administered by the oral route generally should not exceed about 0.005 ml per gram of animal. Even when aqueous or physiological saline solutions are used for parenteral injection the volumes that are tolerated are limited, although such solutions are ordinarily thought of as being innocuous. The intravenous LD₅₀ of distilled water in the mouse is approximately 0.044 ml per gram and that of isotonic saline is 0.068 ml per gram of mouse. In some instances, the route of administration to the test animal should be the same as, or as similar as possible to, the route of administration of the compound to man for therapeutic purposes.

When a compound is to be administered by inhalation, special techniques for generating test atmospheres are necessary. The methods usually involve aerosolization or nebulization of fluids containing the compound. If the agent to be tested is a fluid that has an appreciable vapor pressure, it may be administered by passing air through the solution under controlled temperature conditions. Under these conditions, dose is estimated from the volume of air inhaled per unit time, the temperature of the solution, and the vapor pressure of the agent involved. Gases are metered from reservoirs. When particles of a solution are to be administered, unless the particle size is less than about 2 μm the particles will not reach the terminal alveolar sacs in the lungs. A variety of apparati and chambers are available to perform studies for detecting effects of irritant or other toxic endpoints when they are administered by inhalation. The preferred method of administering an agent to animals is via the oral route, either by intubation or by incorporating the agent in the feed.

When the agent is exposed to cells in vitro or in cell culture, the cell population to be exposed to the agent may be divided into two or more subpopulations, for instance, by dividing the population into two or more identical aliquots. In some preferred embodiments of the methods of the invention, the cells to be exposed to the agent are derived from liver tissue. For instance, cultured or freshly isolated rat hepatocytes may be used.

The methods of the invention may be used generally to predict at least one toxic response, and, as described in the Examples, may be used to predict the likelihood that a compound or test agent will induce various specific pathologies, such as liver cholestasis, genotoxicity/carcinogenesis, hepatitis, human-specific toxicity, induction of liver enlargement, steatosis, macrovesicular steatosis, microvesicular steatosis, necrosis, non-genotoxic/non-carcinogenic toxicity, peroxisome proliferation, rat non-genotoxic toxicity, general hepatotoxicity, or other pathologies associated with at least one known toxin. The methods of the invention may also be used to determine the similarity of a toxic response to one or more individual compounds. In addition, the methods of the invention may be used to predict or elucidate the potential cellular pathways influenced, induced or modulated by the compound or test agent.

### Databases and Computer Systems

Databases and computer systems of the present invention typically comprise one or more data structures comprising toxicity or toxicology models as described herein, including models comprising individual gene or toxicology marker weighted index scores or PLS scores (See Table 2), gene regulation scores, sample prediction scores and/or toxicity reference prediction scores. Such databases and computer systems may also comprise software that allows a user to manipulate the database content or to calculate or generate scores as described herein, including individual gene regulation scores and sample prediction scores from nucleic acid hybridization data. Software may also allow a user to predict, assay for or screen for at least one toxic response, including toxicity, hepatotoxicity, renal toxicity, etc, to include gene or protein pathway information and/or to include information related to the mechanism of toxicity, including possible cellular and molecular mechanisms. As an example, software may include at least one element from the Gene Logic ToxShield™ Predictive Modeling System such as software comprising at least one algorithm to convert hybridization data from varying platforms, for instance from one microarray platform to a second microarray platform (see U.S. Provisional Application 60/613,831, filed Sep. 29, 2004, which is herein incorporated by reference in its entirety for all purposes).

As discussed above, the databases and computer systems of the invention may comprise equipment and software that allow access directly or through a remote link, such as direct dial-up access or access via a password protected Internet link.

Any available hardware may be used to create computer systems of the invention. Any appropriate computer platform, user interface, etc. may be used to perform the necessary comparisons between sequence information, gene or toxicology marker information and any other information in the database or information provided as an input. For example, a large number of computer workstations are available from a variety of manufacturers. Client/server environments, database servers and networks are also widely available and appropriate platforms for the databases of the invention.

The databases may be designed to include different parts, for instance a sequence database and a toxicology reference database. Methods for the configuration and construction of such databases and computer-readable media containing such databases are widely available, for instance, see U.S. Publication No. 2003/0171876 (Ser. No. 10/090,144), filed Mar. 5, 2002, PCT Publication No. WO 02/095659, published Nov. 23, 2002, and U.S. Pat. No. 5,953,727, which are herein incorporated by reference in their entirety. In a preferred embodiment, the database is a ToxExpress® or BioExpress® database marketed by Gene Logic Inc., Gaithersburg, Md.

The databases of the invention may be linked to an outside or external database such as GenBank (www ncbi.nlm.nih.gov/entrez.index.html); KEGG (www.genome.ad.jp/kegg); SPAD (www.grt.kyushu-u.ac.jp/spad/index.html); HUGO (www.gene.ucl.ac.uk/hugo); Swiss-Prot (www.expasy.ch.sprot); Prosite (www.expasy.ch/tools/scnpsit1. html); OMIM (www.ncbi.nlm.nih.gov/omim); and GDB (www.gdb.org). In a preferred embodiment, the external database is GenBank and the associated databases maintained by the National Center for Biotechnology Information (NCBI) (www.ncbi.nlm.nih.gov).

### Toxicity or Toxicology Reports

As descried above, the methods, databases and computer systems of the invention can be used to produce, deliver and/or send a toxicity or toxicology report. As consistent with the use of the terms “toxicity” and “toxicology” as used herein, a “toxicity report” and a “toxicology report” are interchangeable.

The toxicity report of the invention typically comprises information or data related to the results of the practice of a method of the invention. For instance, the practice of a method of identifying at least one toxic effect of a test agent or compound as herein described may result in the preparation or production of a report describing the results of the method including an indication or prediction of at least one toxic response, such as toxicity, hepatotoxicity, renal toxicity, etc. The report may comprise information related to the toxic effects predicted by the comparison of at least one sample prediction score to at least one toxicity reference prediction score from the database as well as other related information such as a literature review or citation list and/or information regarding potential toxicity mechanism(s) of action, etc. The report may also present information concerning the nucleic acid hybridization data, such as the integrity of the data as well as information input by the user of the database and methods of the invention, such as information used to annotate the nucleic acid hybridization data.

As an exemplary, non-limiting example, a toxicity report of the invention may be in a form such as the reports disclosed in PCT US02/22701, filed Jul. 18, 2002, and U.S. Provisional Application 60/613,831, filed Sep. 29, 2004, both of which are herein incorporated by reference in their entirety for all purposes. As described elsewhere in this specification, the report may be generated by a server or computer system to which is loaded nucleic acid hybridization data by a user. The report related to that nucleic acid data may be generated and delivered to the user via remote means such as a password secured environment available over the Internet or via available computer communication means such as email.

### Generating Nucleic Acid Hybridization Data

Any assay format to detect gene expression may be used to produce nucleic acid hybridization data. For example, traditional Northern blotting, dot or slot blot, nuclease protection, primer directed amplification, RT-PCR, semi- or quantitative PCR, branched-chain DNA and differential display methods may be used for detecting gene expression levels or producing nucleic acid hybridization data. Those methods are useful for some embodiments of the invention. In cases where smaller numbers of genes are detected, amplification based assays may be most efficient. Methods and assays of the invention, however, may be most efficiently designed with high-throughput hybridization-based methods for detecting the expression of a large number of genes.

To produce nucleic acid hybridization data, any hybridization assay format may be used, including solution-based and solid support-based assay formats. Solid supports containing oligonucleotide probes for differentially expressed genes of the invention can be filters, polyvinyl chloride dishes particles, beads, microparticles or silicon or glass based chips, etc. Such chips, wafers and hybridization methods are widely available, for example, those disclosed by Beattie (WO 95/11755).

Any solid surface to which oligonucleotides can be bound, either directly or indirectly, either covalently or non-covalently, can be used. A preferred solid support is a high density array or DNA chip. These contain a particular oligonucleotide probe in a predetermined location on the array. Each predetermined location may contain more than one molecule of the probe, but each molecule within the predetermined location has an identical sequence. Such predetermined locations are termed features. There may be, for example, from 2, 10, 100, 1000 to 10,000, 100,000 or 400,000 or more of such features on a single solid support. The solid support, or the area within which the probes are attached may be on the order of about a square centimeter. Probes corresponding to the genes of Tables 1-2 or from the related applications described above may be attached to single or multiple solid support structures, e.g., the probes may be attached to a single chip or to multiple chips to comprise a chip set.

Oligonucleotide probe arrays, including bead assays or collections of beads, for expression monitoring can be made and used according to any techniques known in the art (see for example, Lockhart et al. (1996), Nat Biotechnol 14:1675-1680; McGall et al. (1996), Proc Nat Acad Sci USA 93: 13555-13460). Such probe arrays may contain at least two or more oligonucleotides that are complementary to or hybridize to two or more of the genes described in Table 2. For instance, such arrays may contain oligonucleotides that are complementary to or hybridize to at least about 2, 3, 4, 5, 6, 7, 8, 9, 10, 20, 30, 50, 70, 100, 500 or 1,000 or more of the genes described herein.

The sequences of the toxicity expression marker genes of Table 2 are in the public databases. Table 1 provides the SEQ ID NO: and GenBank Accession Number (NCBI RefSeq ID) for each of the sequences (see www.ncbi.nlm.nih.gov/), as well as the title for the cluster of which gene is part. The sequences of the genes in GenBank are expressly herein incorporated by reference in their entirety as of the filing date of this application, as are related sequences, for instance, sequences from the same gene of different lengths, variant sequences, polymorphic sequences, genomic sequences of the genes and related sequences from different species, including the human counterparts, where appropriate.

The terms “background” or “background signal intensity” refer to hybridization signals resulting from non-specific binding, or other interactions, between the labeled target nucleic acids and components of the oligonucleotide array (e.g., the oligonucleotide probes, control probes, the array substrate, etc.). Background signals may also be produced by intrinsic fluorescence of the array components themselves. A single background signal can be calculated for the entire array, or a different background signal may be calculated for each target nucleic acid. In a preferred embodiment, background is calculated as the average hybridization signal intensity for the lowest 5% to 10% of the probes in the array, or, where a different background signal is calculated for each target gene, for the lowest 5% to 10% of the probes for each gene. Of course, one of skill in the art will appreciate that where the probes to a particular gene hybridize well and thus appear to be specifically binding to a target sequence, they should not be used in a background signal calculation. Alternatively, background may be calculated as the average hybridization signal intensity produced by hybridization to probes that are not complementary to any sequence found in the sample (e.g. probes directed to nucleic acids of the opposite sense or to genes not found in the sample such as bacterial genes where the sample is mammalian nucleic acids). Background can also be calculated as the average signal intensity produced by regions of the array that lack any probes at all.

The phrase “hybridizing specifically to” or “specifically hybridizes” refers to the binding, duplexing, or hybridizing of a molecule substantially to or only to a particular nucleotide sequence or sequences under stringent conditions when that sequence is present in a complex mixture (e.g., total cellular) DNA or RNA.

As used herein a “probe” is defined as a nucleic acid, capable of binding to a target nucleic acid of complementary sequence through one or more types of chemical bonds, usually through complementary base pairing, usually through hydrogen bond formation. As used herein, a probe may include natural (i.e., A, G, U, C, or T) or modified bases (7-deazaguanosine, inosine, etc.). In addition, the bases in probes may be joined by a linkage other than a phosphodiester bond, so long as it does not interfere with hybridization. Thus, probes may be peptide nucleic acids in which the constituent bases are joined by peptide bonds rather than phosphodiester linkages.

### Nucleic Acid Samples

Cell or tissue samples may be exposed to the test agent in vitro or in vivo. When cultured cells or tissues are used, appropriate mammalian cell extracts, such as liver extracts, may also be added with the test agent to evaluate agents that may require biotransformation to exhibit toxicity. In a preferred format, primary isolates or cultured cell lines of animal or human renal cells may be used.

The genes which are assayed according to the present invention are typically in the form of mRNA or reverse transcribed mRNA. The genes may or may not be cloned. The genes may or may not be amplified. The cloning and/or amplification do not appear to bias the representation of genes within a population. In some assays, it may be preferable, however, to use polyA+ RNA as a source, as it can be used with fewer processing steps.

As is apparent to one of ordinary skill in the art, nucleic acid samples used in the methods and assays of the invention may be prepared by any available method or process. Methods of isolating total mRNA are well known to those of skill in the art. For example, methods of isolation and purification of nucleic acids are described in detail in Chapter 3 of Laboratory Techniques in Biochemistry and Molecular Biology, Vol. 24, Hybridization With Nucleic Acid Probes: Theory and Nucleic Acid Probes, P. Tijssen, Ed., Elsevier Press, New York, 1993. Such samples include RNA samples, but also include cDNA synthesized from a mRNA sample isolated from a cell or tissue of interest. Such samples also include DNA amplified from the cDNA, and RNA transcribed from the amplified DNA. One of skill in the art would appreciate that it is desirable to inhibit or destroy RNase present in homogenates before homogenates are used.

Biological samples may be of any biological tissue or fluid or cells from any organism as well as cells raised in vitro, such as cell lines and tissue culture cells. Frequently the sample will be a tissue or cell sample that has been exposed to a compound, agent, drug, pharmaceutical composition, potential environmental pollutant or other composition. In some formats, the sample will be a “clinical sample” which is a sample derived from a patient. Typical clinical samples include, but are not limited to, sputum, blood, blood-cells (e.g., white cells), tissue or fine needle biopsy samples, urine, peritoneal fluid, and pleural fluid, or cells therefrom. Biological samples may also include sections of tissues, such as frozen sections or formalin fixed sections taken for histological purposes.

### Hybridization

Nucleic acid hybridization simply involves contacting a probe and target nucleic acid under conditions where the probe and its complementary target can form stable hybrid duplexes through complementary base pairing. See WO 99/32660. The nucleic acids that do not form hybrid duplexes are then washed away leaving the hybridized nucleic acids to be detected, typically through detection of an attached detectable label. It is generally recognized that nucleic acids are denatured by increasing the temperature or decreasing the salt concentration of the buffer containing the nucleic acids. Under low stringency conditions (e.g., low temperature and/or high salt) hybrid duplexes (e.g., DNA:DNA, RNA:RNA, or RNA:DNA) will form even where the annealed sequences are not perfectly complementary. Thus, specificity of hybridization is reduced at lower stringency. Conversely, at higher stringency (e.g., higher temperature or lower salt) successful hybridization tolerates fewer mismatches. One of skill in the art will appreciate that hybridization conditions may be selected to provide any degree of stringency.

In a preferred embodiment, hybridization is performed at low stringency, in this case in 6×SSPET at 37° C. (0.005% Triton X-100), to ensure hybridization and then subsequent washes are performed at higher stringency (e.g., 1×SSPET at 37° C.) to eliminate mismatched hybrid duplexes. Successive washes may be performed at increasingly higher stringency (e.g., down to as low as 0.25×SSPET at 37° C. to 50° C.) until a desired level of hybridization specificity is obtained. Stringency can also be increased by addition of agents such as formamide. Hybridization specificity may be evaluated by comparison of hybridization to the test probes with hybridization to the various controls that can be present (e.g., expression level control, normalization control, mismatch controls, etc.).

In general, there is a tradeoff between hybridization specificity (stringency) and signal intensity. Thus, in a preferred embodiment, the wash is performed at the highest stringency that produces consistent results and that provides a signal intensity greater than the background intensity. Thus, in a preferred embodiment, the hybridized array may be washed at successively higher stringency solutions and read between each wash. Analysis of the data sets thus produced will reveal a wash stringency above which the hybridization pattern is not appreciably altered and which provides adequate signal for the particular oligonucleotide probes of interest.

### Kits

The invention further includes kits combining, in different combinations, high-density oligonucleotide arrays, reagents for use with the arrays, signal detection and array-processing instruments, toxicology databases and analysis and database management software described above. The kits may be used, for example, to predict or model the toxic response of a test compound.

The databases that may be packaged with the kits are described above. In particular, the database software and packaged information may contain the databases saved to a computer-readable medium, or transferred to a user's local server. In another format, database and software information may be provided in a remote electronic format, such as a website, the address of which may be packaged in the kit.

Databases and software designed for use with microarrays are discussed in Balaban et al., U.S. Pat. No. 6,229,911, a computer-implemented method for managing information collected from small or large numbers of microarrays, and U.S. Pat. No. 6,185,561, a computer-based method with data mining capability for collecting gene expression level data, adding additional attributes and reformatting the data to produce answers to various queries. Chee et al., U.S. Pat. No. 5,974,164, disclose a software-based method for identifying mutations in a nucleic acid sequence based on differences in probe fluorescence intensities between wild type and mutant sequences that hybridize to reference sequences.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

### EXAMPLES

### Example 1

### Generation of Toxicity Models Using RMA and PLS

Various kidney toxins are administered to male Sprague-Dawley rats at various timepoints using administration diluents, protocols and dosing regimes as previously described in the art and previously described in the priority application discussed above.

As an illustration of the protocols used, the toxins are administered to and animals are sacrificed and kidney samples harvested at the time points indicated below.

### Observation of Animals

1. Clinical cage side observations—twice daily mortality and moribundity check. Skin and fur, eyes and mucous membrane, respiratory system, circulatory system, autonomic and central nervous system, somatomotor pattern, and behavior pattern are checked. Potential signs of toxicity, including tremors, convulsions, salivation, diarrhea, lethargy, coma or other atypical behavior or appearance, are recorded as they occur and include a time of onset, degree, and duration.

2. Physical Examinations-Prior to randomization, prior to initial treatment, and prior to sacrifice.

3. Body Weights-Prior to randomization, prior to initial treatment, and prior to sacrifice.

### Clinical Pathology

1. Frequency—Prior to necropsy.

2. Number of animals—All surviving animals.

3. Bleeding Procedure—Blood was obtained by puncture of the orbital sinus while under 70% CO₂/30% O₂ anesthesia.

4. Collection of Blood Samples-Approximately 0.5 mL of blood is collected into EDTA tubes for evaluation of hematology parameters. Approximately 1 mL of blood is collected into serum separator tubes for clinical chemistry analysis. Approximately 200 μL of plasma is obtained and frozen at ˜−80° C. for test compound/metabolite estimation. An additional ˜2 mL of blood is collected into a 15 mL conical polypropylene vial to which ˜3 mL of Trizol is immediately added. The contents are immediately mixed with a vortex and by repeated inversion. The tubes are frozen in liquid nitrogen and stored at 80° C.

### Termination Procedures

### Terminal Sacrifice

At the time points indicated above, rats are weighed, physically examined, sacrificed by decapitation, and exsanguinated. The animals are necropsied within approximately five minutes of sacrifice. Separate sterile, disposable instruments are used for each animal. Necropsies are conducted on each animal following procedures approved by board-certified pathologists.

Animals not surviving until terminal sacrifice are discarded without necropsy (following euthanasia by carbon dioxide asphyxiation, if moribund). The approximate time of death for moribund or found dead animals is recorded.

### Postmortem Procedures

All tissues are collected and frozen within approximately 5 minutes of the animal's death. Tissues are stored at approximately −80° C. or preserved in 10% neutral buffered formalin.

### Tissue Collection and Processing

Liver

1. Right medial lobe—snap freeze in liquid nitrogen and store at ˜−80° C.
2. Left medial lobe—Preserve in 10% neutral-buffered formalin (NBF) and evaluate for gross and microscopic pathology.
3. Left lateral lobe—snap freeze in liquid nitrogen and store at ˜−80° C.

Heart

1. A sagittal cross-section containing portions of the two atria and of the two ventricles is preserved in 10% NBF. The remaining heart is frozen in liquid nitrogen and stored at ˜−80° C.

Kidneys (Both)

1. Left—Hemi-dissect; half is preserved in 10% NBF and the remaining half is frozen in liquid nitrogen and stored at ˜−80° C.
2. Right—Hemi-dissect; half is preserved in 10% NBF and the remaining half is frozen in liquid nitrogen and stored at ˜−80° C.

Testes (both)—A sagittal cross-section of each testis is preserved in 10% NBF. The remaining testes are frozen together in liquid nitrogen and stored at ˜−80° C.

Brain (whole)—A cross-section of the cerebral hemispheres and of the diencephalon are preserved in 10% NBF, and the rest of the brain is frozen in liquid nitrogen and stored at ˜−80° C.

Microarray sample preparation is conducted with minor modifications, following the protocols set forth in the Affymetrix GeneChip® Expression Technical Analysis Manual (Affymetrix, Inc. Santa Clara, Calif.). Frozen tissue is ground to a powder using a Spex Certiprep 6800 Freezer Mill. Total RNA is extracted with Trizol (Invitrogen, Carlsbad Calif.) utilizing the manufacturer's protocol. mRNA is isolated using the Oligotex mRNA Midi kit (Qiagen) followed by ethanol precipitation. Double stranded cDNA is generated from mRNA using the SuperScript Choice system (Invitrogen, Carlsbad Calif.). First strand cDNA synthesis is primed with a T7-(dT24) oligonucleotide. The cDNA is phenol-chloroform extracted and ethanol precipitated to a final concentration of 1 μg/ml. From 2 μg of cDNA, cRNA is synthesized using Ambion's T7 MegaScript in vitro Transcription Kit.

To biotin label the cRNA, nucleotides Bio-11-CTP and Bio-16-UTP (Enzo Diagnostics) are added to the reaction. Following a 37° C. incubation for six hours, impurities are removed from the labeled cRNA following the RNeasy Mini kit protocol (Qiagen). cRNA is fragmented (fragmentation buffer consisting of 200 mM Tris-acetate, pH 8.1, 500 mM KOAc, 150 mM MgOAc) for thirty-five minutes at 94° C. Following the Affymetrix protocol, 55 μg of fragmented cRNA is hybridized on the Affymetrix rat array set for twenty-four hours at 60 rpm in a 45° C. hybridization oven. The chips are washed and stained with Streptavidin Phycoerythrin (SAPE) (Molecular Probes) in Affymetrix fluidics stations. To amplify staining, SAPE solution is added twice with an anti-streptavidin biotinylated antibody (Vector Laboratories) staining step in between. Hybridization to the probe arrays is detected by fluorometric scanning (Hewlett Packard Gene Array Scanner). Data is analyzed using Affymetrix GeneChip® and Expression Data Mining (EDMT) software, the GeneExpress® database, and S-Plus® statistical analysis software (Insightful Corp.).

Identification of Toxicity Markers and Model Building using RMA and PLS Algorithms

RMA/PLS models are built as follows. From DNA microarray data from one or more studies, a matrix of RMA fold-change expression values is generated. These values are generated, for example, according to the method of Irizarry et al. (Nucl Acids Res 31(4):e15, 2003), which uses the following equation to produce a log scale linear additive model: T(PMᵢⱼ)=eᵢ+aⱼ+εᵢⱼ. T represents the transformation that corrects for background and normalizes and converts the PM (perfect match) intensities to a log scale. eᵢ represents the log 2 scale expression values found on arrays i=1−I, aⱼ represents the log scale affinity effects for probes j=1−J, and εᵢⱼ represents error (to correct for the differences in variances when using probes that bind with different intensities).

In RMA fold-change matrices, the rows represent individual fragments, and the columns are individual samples. A vehicle cohort median matrix is then calculated, in which the rows represent fragments and the columns represent vehicle cohorts, one cohort for each study/time-point combination. The values in this matrix are the median RMA expression values across the samples within those cohorts. Next, a matrix of normalized RMA expression values is generated, in which the rows represent individual fragments and the columns are individual samples. The normalized RMA values are the RMA values minus the value from the vehicle cohort median matrix corresponding to the time-matched vehicle cohort. PLS modeling is then applied to the normalized RMA matrix (a subset by taking certain fragments as described below), using a −1=non-tox, +1=tox supervised score vector as the dependant variable and the rows of normalized RMA matrix as the independent variables. PLS works by computing a series of PLS components, where each component is a weighted linear combination of fragment values. We use the nonlinear iterative partial least squares method to compute the PLS components.

To select fragments, a vehicle cohort mean matrix is generated, in which the rows represent fragments and the columns represent vehicle cohorts, one cohort for each study/time-point combination. The values in this matrix are the mean RMA expression values across the samples within those cohorts. A treated cohort mean matrix is then generated, in which the rows represent fragments and the columns represent treated (non-vehicle) cohorts, one cohort for each study/time-point/compound/dose combination. The values in this matrix are the mean RMA expression values across the samples within those cohorts. Next, a treated cohort fold-change matrix is generated, in which the rows represent fragments and the columns represent treated cohorts, one cohort for each study/time-point/compound/dose combination. The values in this matrix are the values in the treated cohort mean matrix minus the values in the vehicle cohort mean matrix corresponding to appropriate time-matched vehicle cohorts. Subsequently, a treated cohort p-value matrix is generated, in which the rows represent fragments and the columns represent treated cohorts, one cohort for each study/time-point/compound/dose combination. The values in this matrix are p-values based on two-sample t-tests comparing the treated cohort mean values to the vehicle cohort mean values corresponding to appropriate time-matched vehicle cohorts. This matrix is converted to a binary coding based on the p-values being less than 0.05 (coded as 1) or greater than 0.05 (coded as 0).

The row sums of the binary treated cohort p-value matrix are computed, where that row sum represents a “gene regulation score” for each fragment, representing the total number of treated cohorts where the fragment showed differential regulation (up- or down-regulation) compared to its time-matched vehicle cohort. PLS modeling and ⅔/⅓ cross-validation are then performed based on taking the top N fragments according to the regulation score, varying N and the number of PLS components, and recording the model success rate for each combination. N is chosen to be the point at which the cross-validated error rate are minimized. In the PLS model, each of those N fragments receives a PLS weight (PLS score) corresponding to the fragment's utility, or predictive ability, in the model (see Table 2 for an exemplary list of PLS scores for a kidney general toxicity model).

### Example 2

### Methods of Predicting at Least One Toxic Effect of a Test Agent

To determine whether or not a sample from an animal treated with a test agent or compound exhibits at least one toxic effect or response, RNA is prepared from a cell or tissue sample exposed to the agent and hybridized to a DNA microarray, as described in Example 1 above. From the nucleic acid hybridization data, a prediction score is calculated for that sample and compared to a reference score from a toxicity reference database according to the following equation. The sample prediction score=ΣwᵢR^{FC}^{ᵢ}. “i” is the index number for each gene in a gene expression profile to be evaluated. “wᵢ” is the PLS weight (or PLS score, see Table 2 for an exemplary list of PLS scores for a general kidney toxicity model) for each gene. “R^{FC}^{ᵢ}” is the RMA fold-change value for the i^{th} gene, as determined from a normalized RMA matrix of gene expression data from the sample (described above). The PLS weight multiplied by the RMA fold-change value gives a gene regulation score for each gene, and the regulation scores for all the individual genes are added to give a prediction score for the sample.

As a quality control (QC) check, for each incoming study, an average correlation assessment is performed. After the RMA matrix is generated (genes by samples), a Pearson correlation matrix is calculated of the samples to each other. This matrix is samples by samples. For each sample row of the matrix, the mean of all correlation values in that row of the matrix, excluding the diagonal (which is always 1) is calculated. This mean is the average correlation for that sample. If the average correlation is less than a threshold (for instance 0.90), the sample is flagged as a potential outlier. This process is repeated for each row (sample) in the study. Outliers flagged by the average correlation QC check are dropped out of any downstream normalization, prediction or compound similarity steps in the process.

To establish a toxicity prediction score cut-off value for a toxicity model, the true-positive and false positive rates for each possible score cut-off value are computed, using the scores from all tox and non-tox samples in the training set. This generates an ROC curve, which we use to set the cut-off score at the point on the ROC curve corresponding to ˜5% false positive rate. For example, in a kidney toxicity model of Table 2, a cut-off prediction score is about 0.318. If the sample score is about 0.318 or above, it can be predicted that the sample shows a toxic response after exposure to the test compound. If the sample score is below 0.318, it can be predicted that the sample does not show a toxic response

The model can be trained by setting a score of −1 for each gene that cannot predict a toxic response and by setting a score of +1 for each gene that can predict a toxic response. Cross-validation of RMA/PLS models may be performed by the compound-drop method and by the ⅔:⅓ method. In the compound-drop method, sample data from animals treated with one particular test compound are removed from a model, and the ability of this model to predict toxicity is compared to that of a model containing a full data set. In the ⅔:⅓ method, gene expression information from a random third of the genes in the model is removed, and the ability of this subset model to predict toxicity is compared to that of a model containing a full data set.

Compound similarity is assessed in the following way. In the same manner as described above, a cohort fold-change vector for each study/time-point/compound/dose combination is calculated. This vector is reduced to only the fragments used in the PLS predictive models. We then calculate Pearson correlations for that cohort fold-change vector with each cohort vector (also reduced to only the fragments used in the PLS predictive models) in our reference database. Finally, these Pearson correlations are ranked from highest to lowest and the results are reported.

A report may be generated comprising information or data related to the results of the methods of predicting at least one toxic effect. The report may comprise information related to the toxic effects predicted by the comparison of at least one sample prediction score to at least one toxicity reference prediction score from the database. The report may also present information concerning the nucleic acid hybridization data, such as the integrity of the data as well as information inputted by the user of the database and methods of the invention, such as information used to annotate the nucleic acid hybridization data. See PCT US02/22701 for a non-limiting example of a toxicity report that may be generated.

### Example 3

### Converting RMA Data from One Platform to Another

An algorithm was developed to convert probe intensity data from a first type of microarray to RMA data of a second type of microarray. This is beneficial to the customer because it provides the customer with the freedom to select the type of microarray it wishes to use with a RMA/PLS predictive model. Frequently this is the newest microarray on the market. The algorithm is beneficial for the company which builds RMA/PLS statistical models on microarray data because money and resources do not have to be expended to rebuild statistical models built on discontinued microarrays.

The conversion algorithm developed can be used on data from the Affymetrix GeneChip® rat RAE 2.0 microarray to Affymetrix GeneChip® rat RGU34 A microarray data. This conversion also allows the use of RMA/PLS toxicogenomics models built on the Affymetrix RGU34 A microarray platform to predict customer data generated on the RAE2.0 microarray platform. The conversion algorithm was tested using the liver toxicity model described in U.S. Provisional Application Ser. No. 60/559,949 and herein incorporated by reference.

The first step to using a conversion algorithm is to map microarray fragments. The RGU34 A microarray fragments which comprise the liver toxicity model were mapped to the RAE2.0 microarray. The liver toxicity model is based on 1,100 Affymetrix GeneChip® RGU34 A microarray fragments. Of the 1,100 fragments in the model, 907 were suggested by Affymetrix as matching to fragments on the RAE2.0 microarray. See Affymetrix's “User's Guide to Product Comparison Spreadsheets” which is herein incorporated by reference. Another 105 fragments mapped to fragments sharing the same RefSeq ID and 55 mapped to fragments which mapped to the same UniGene cluster. The 1067 mapping fragments were reduced to 1053. The 1053 mapped fragments represented 16 RGU34 A and 11 RAE 2.0 probes. The 47 fragments which were not mapped to the RAE2.0 microarray were assigned an RMA fold-change value of 0 for all samples and did not contribute to the prediction.

Once the microarray fragments are mapped, training samples are selected to calculate the conversion model weights. The inventors searched Gene Logic's ToxExpress® reference database, a database which is built on the Affymetrix RGU34A platform, for samples that covered a large amount of interquartile range with respect to signal intensity. Samples that covered the largest amount of variable space were selected because this method of sample selection had previously been determined by the inventors to be reliable in the development of a human sample conversion algorithm. The samples maximized Eᵢ(Max(Xᵢⱼ)−Min(Xᵢⱼ)), where i indexes genes and j indexes samples.

The inventors found that sample size calculations were stable at a sampling of approximately 100 microarrays. For this reason, a training set consisting of 100 compounds and vehicles from rat liver tissue was selected.

The 100 training samples were used to train the weights in the conversion algorithm. This step is important because it provides for the quantitative aspect of the conversion. The weight training was performed based on a multiple regression analysis with probe values as the independent variables and RMA expression as the sum of the dependent variables.

Test samples were evaluated using the trained conversion algorithm. The multiple regression model was built on the 11 perfect match probe intensities and generated a predicted RGU34 expression value from a weighted sum of RAE 2.0 probe values. Each test array was scaled to an average probe intensity of 10 (log scale). The conversion algorithm used is given as:

Yᵢ^{RGU34}=βᵢₒ+Σβiⱼ LOG(Xiⱼ^{RAE2.0}/S)

where Y is the RGU34 RMA expression value for a fragment; Xᵢⱼ^{RAE2.0} for i=1 . . . 1053, j=1 . . . 11 are perfect match probe intensity values for the marker genes on the RAE2.0 microarray; S is a chip scale factor ΣᵢⱼXᵢⱼ^{RAE2.0}/n. Probe intensities were first floored to the minimum intensity value of 30.

Alternative approaches to using a multiple regression model exist to convert RAE2.0 data to RGU34 RMA data. Non-linear regression on probe values as well as canonical correlation of RAE2.0 probes to RGU34 A probes could be used. RMA values on a RAE2.0 microarray could be computed and then scaled or quantile-normalized to RGU34 A RMA values. In addition, although the multiple regression analysis used in this example does not take into account mismatched probes, an analysis could be used which takes into account mismatched probes.

The liver predictive model was used to compare the predictive results of test data from the RGU34 microarray to test data derived from converted RAE2.0 array data. The consistency between the RGU34 array results and the converted RAE2.0 array results was quite high. Table 3 provides the number of test samples per compound which were predicted as toxic out of the total number of samples for that compound using RGU34 RMA data and RAE2.0 converted RMA data. Amitryptilene, estradiol, amiodarone, diflunisal, phenobarbital, dioxin, ethionine, and LPS were selected as test toxicants. Clofibrate was selected because it is a rat-specific toxicant. Metformin, rosiglitazone, chlorpheniramine, and streptomycin were selected as test negative controls. The rat-specific toxicant and all of the tested negative controls correctly predicted no toxicity.

TABLE 3

| Treatment | RGU34 | RAE2.0 converted |
|---|---|---|
| Amitryptilene | 1/2 | 2/2 |
| Estradiol | 3/3 | 3/3 |
| Amiodarone | 2/3 | 2/3 |
| Diflunisal | 2/3 | 2/3 |
| Phenobarbital | 3/3 | 3/3 |
| Dioxin | 3/3 | 2/3 |
| Ethionine | 3/3 | 3/3 |
| LPS | 3/3 | 3/3 |
| Clofibrate | 0/3 | 0/3 |
| Metformin | 0/3 | 0/3 |
| Rosiglitazone | 0/3 | 0/3 |
| Chlorpheniramine | 0/3 | 0/3 |
| Streptomycin | 0/3 | 0/3 |

### Example 4

### Database

A web-based software predictive modeling system called the ToxShield™ Suite was created which is composed of a collection of RMA/PLS toxicity predictive models. Liver RMA/PLS predictive models were built to allow a user to identify and classify various toxic and mechanistic responses to unknown or test compounds. The models represent a wide variety of endpoint pathologies and indications, including general toxicity, necrosis, steatosis, macrovesicular steatosis, microvesicular steatosis, cholestasis, hepatitis, carcinogenicity, genotoxic carcinogenicity, non-genotoxic carcinogenicity, rat specific non-genotoxic carcinogenicity, peroxisome proliferation, and inducer/liver enlargement. The outcome of toxicity models represents a detailed categorization of test or unknown compounds from which mechanistic information can be inferred. Although the current models available as part of this software system are related to liver toxicity, models relating to specific toxicities of other organs including, but not limited to, liver primary cell culture, kidney, heart, spleen, bone marrow, and brain could be used.

The conversion algorithm described in Example 3 can be implemented in a software product such as the ToxShield™ Suite. The customer inputs his or her data that has been generated on a microarray such as the Affymetrix RAE2.0 GeneChip® microarray platform. The software utilizes the algorithm to convert the customer's gene expression data to RMA data which is compatible with the software's toxicogenomics model built which was built exclusively on a second microarray platform such as the Affymetrix RGU34 A GeneChip® microarray. Visualizations and predictions can then be generated from the customer's data using the predictive model.

Although the present invention has been described in detail with reference to examples above, it is understood that various modifications can be made without departing from the spirit of the invention. Accordingly, the invention is limited only by the following claims. All cited patents, patent applications and publications referred to in this application are herein incorporated by reference in their entirety.

TABLE 1

| | | GenBank Acc or | | |
|---|---|---|---|---|
| GLGC Identifier | Seq ID | RefSeq ID | Known Gene Name | UniGene Cluster Title |
| 25098 | 2 | AA108277 | | |
| 18396 | 8 | AA799330 | | Rattus norvegicus transcribed sequence with strong similarity to protein |
| | | | | ref: NP_057030.1 (H. sapiens) CGI-17 protein; pelota (Drosophila) homolog [Homo sapiens] |
| 18291 | 12 | AA799497 | | Rattus norvegicus transcribed sequences |
| 23063 | 14 | AA799534 | | Rattus norvegicus transcribed sequences |
| 18361 | 16 | AA799591 | | Rattus norvegicus transcribed sequence with strong similarity to protein |
| | | | | prf: 1202265A (R. norvegicus) 1202265A tubulin T beta15 [Rattus norvegicus] |
| 14309 | 19 | AA799676 | | Rattus norvegicus transcribed sequences |
| 21007 | 22 | AA799861 | | Rattus norvegicus transcribed sequence with strong similarity to protein sp.P70434 |
| | | | | (M. musculus) IRF7_MOUSE Interferon regulatory factor 7 (IRF-7) |
| 23203 | 23 | AA799971 | | Rattus norvegicus transcribed sequence with moderate similarity to protein |
| | | | | ref: NP_060761.1 (H. sapiens) hypothetical protein FLJ10986 [Homo sapiens] |
| 4412 | 26 | AA800005 | CD151 antigen | CD151 antigen |
| 21035 | 27 | AA800025 | | Rattus norvegicus transcribed sequence with strong similarity to protein |
| | | | | ref: NP_542787.1 (H. sapiens) chromosome 20 open reading frame 163 [Homo sapiens] |
| 18462 | 32 | AA800708 | | Rattus norvegicus transcribed sequences |
| 22386 | 37 | AA800844 | | Rattus norvegicus transcribed sequence with moderate similarity to protein |
| | | | | sp: P16636 (R. norvegicus) LYOX_RAT Protein-lysine 6-oxidase precursor (Lysyl oxidase) |
| 15022 | 38 | AA801029 | nuclear receptor subfamily 2, group F, member 6 | nuclear receptor subfamily 2, group F, member 6 |
| 20753 | 43 | AA801441 | platelet-activating factor acetylhydrolase beta subunit (PAF-AH beta) | platelet-activating factor acetylhydrolase beta subunit (PAF-AH beta) |
| 2109 | 47 | AA817887 | profilin | profilin |
| 9125 | 67 | AA819338 | signal sequence receptor 4 | signal sequence receptor 4 |
| 8888 | 81 | AA849036 | guanylate cyclase 1, soluble, alpha 3 | guanylate cyclase 1, soluble, alpha 3 |
| 1867 | 91 | AA850940 | ribosomal protein L4 | ribosomal protein L4 |
| 17411 | 102 | AA858621 | CaM-kinase II inhibitor alpha | CaM-kinase II inhibitor alpha |
| 12700 | 104 | AA858673 | pancreatic secretory trypsin inhibitor type II (PSTI-II) | pancreatic secretory trypsin inhibitor type II (PSTI-II) |
| 14124 | 112 | AA859305 | tropomyosin isoform 6 | tropomyosin isoform 6 |
| 4178 | 114 | AA859536 | | Rattus norvegicus transcribed sequence with strong similarity to protein sp: P07153 |
| | | | | (R. norvegicus) RIB1_RAT Dolichyl-diphosphooligosaccharide--protein |
| | | | | glycosyltransferase 67 kDa subunit precursor (Ribophorin I) (RPN-I) |
| 15150 | 115 | AA859562 | | |
| 11852 | 117 | AA859593 | | Rattus norvegicus transcribed sequence with moderate similarity to protein |
| | | | | pdb: 1LBG (E. coli) B Chain B, Lactose Operon Repressor Bound To 21-Base Pair |
| | | | | Symmetric Operator Dna, Alpha Carbons Only |
| 4809 | 118 | AA859616 | | Rattus norvegicus transcribed sequence with weak similarity to protein |
| | | | | ref: NP_502422.1 (C. elegans) FYVE zinc finger [Caenorhabditis elegans] |
| 19067 | 119 | AA859663 | | Rattus norvegicus transcribed sequence with weak similarity to protein |
| | | | | ref: NP_080153.1 (M. musculus) RIKEN cDNA 2310067G05 [Mus musculus] |
| 20582 | 120 | AA859688 | | Rattus norvegicus transcribed sequence with weak similarity to protein pdb: 1DUB |
| | | | | (R. norvegicus) F Chain F, 2-Enoyl-Coa Hydratase, Data Collected At 100 K, Ph 6.5 |
| 22374 | 122 | AA859804 | | Rattus norvegicus transcribed sequence with weak similarity to protein sp: P20415 |
| | | | | (R. norvegicus) IF4E_MOUSE EUKARYOTIC TRANSLATION INITIATION |
| | | | | FACTOR 4E (EIF-4E) (EIF4E) (MRNA CAP-BINDING PROTEIN) (EIF-4F 25 KDA |
| | | | | SUBUNIT) |
| 22927 | 127 | AA859920 | nucleosome assembly protein 1-like 1 | nucleosome assembly protein 1-like 1 |
| 4222 | 132 | AA860024 | | Rattus norvegicus transcribed sequence with strong similarity to protein |
| | | | | sp: Q9D8N0 (M. musculus) EF1G_MOUSE Elongation factor 1-gamma (EF-1- |
| | | | | gamma) (eEF-1B gamma) |
| 7090 | 134 | AA860039 | | Rattus norvegicus transcribed sequence |
| 15927 | 137 | AA866321 | | Rattus norvegicus transcribed sequences |
| 11865 | 138 | AA866383 | | Rattus norvegicus transcribed sequences |
| 19402 | 140 | AA874848 | Thymus cell surface antigen | Thymus cell surface antigen |
| 16139 | 146 | AA874927 | | Rattus norvegicus transcribed sequences |
| 6451 | 148 | AA875033 | fibulin 5 | fibulin 5 |
| 16419 | 149 | AA875102 | | Rattus norvegicus transcribed sequence with strong similarity to protein sp: P08578 |
| | | | | (M. musculus) RUXE_HUMAN Small nuclear ribonucleoprotein E (snRNP-E) (Sm |
| | | | | protein E) (Sm-E) (SmE) |
| 18084 | 151 | AA875186 | | |
| 15371 | 152 | AA875205 | | Rattus norvegicus transcribed sequence with strong similarity to protein sp: P55884 |
| | | | | (H. sapiens) IF39_HUMAN Eukaryotic translation initiation factor 3 subunit 9 (eIF-3 |
| | | | | eta) (eIF3 p116) (eIF3 p110) |
| 15376 | 153 | AA875206 | ubiquilin 1 | ubiquilin 1 |
| 15887 | 154 | AA875225 | GTP-binding protein (G-alpha-i2) | GTP-binding protein (G-alpha-i2) |
| 15888 | 154 | AA875225 | GTP-binding protein (G-alpha-i2) | GTP-binding protein (G-alpha-i2) |
| 15401 | 155 | AA875257 | | Rattus norvegicus transcribed sequences |
| 18902 | 158 | AA875390 | thioredoxin-like (32 kD) | thioredoxin-like (32 kD) |
| 15505 | 159 | AA875414 | | Rattus norvegicus transcribed sequence with weak similarity to protein |
| | | | | ref: NP_059088.1 (M. musculus) cadherin EGF LAG seven-pass G-type receptor 2 |
| | | | | [Mus musculus] |
| 6153 | 162 | AA875531 | | |
| 24235 | 169 | AA891286 | thioredoxin reductase 1 | thioredoxin reductase 1 |
| 9952 | 170 | AA891422 | hypoxia induced gene 1 | hypoxia induced gene 1 |
| 9071 | 172 | AA891578 | | Rattus norvegicus transcribed sequences |
| 474 | 173 | AA891670 | | Rattus norvegicus transcribed sequence with moderate similarity to protein |
| | | | | ref: NP_034894.1 (M. musculus) mannosidase 2, alpha B1; lysosomal alpha- |
| | | | | mannosidase [Mus musculus] |
| 9091 | 174 | AA891690 | | Rattus norvegicus transcribed sequence with strong similarity to protein |
| | | | | ref: NP_076006.1 (M. musculus) tumor necrosis factor (ligand) superfamily, |
| | | | | member 13 [Mus musculus] |
| 17420 | 175 | AA891693 | | Rattus norvegicus transcribed sequences |
| 18078 | 176 | AA891726 | solute carrier family 34, member 1 | solute carrier family 34, member 1 |
| 20839 | 177 | AA891729 | ribosomal protein S27a | ribosomal protein S27a |
| 11959 | 178 | AA891735 | | Rattus norvegicus transcribed sequences |
| 17693 | 179 | AA891737 | | Rattus norvegicus transcribed sequences |
| 17289 | 185 | AA891785 | | Rattus norvegicus transcribed sequence with weak similarity to protein sp: P41562 |
| | | | | (R. norvegicus) IDHC_RAT ISOCITRATE DEHYDROGENASE [NADP] |
| | | | | CYTOPLASMIC (OXALOSUCCINATE DECARBOXYLASE) (IDH) (NADP+- |
| | | | | SPECIFIC ICDH) (IDP) |
| 17290 | 185 | AA891785 | | Rattus norvegicus transcribed sequence with weak similarity to protein sp: P41562 |
| | | | | (R. norvegicus) IDHC_RAT ISOCITRATE DEHYDROGENASE [NADP] |
| | | | | CYTOPLASMIC (OXALOSUCCINATE DECARBOXYLASE) (IDH) (NADP+- |
| | | | | SPECIFIC ICDH) (IDP) |
| 20522 | 190 | AA891842 | | Rattus norvegicus transcribed sequence with weak similarity to protein |
| | | | | ref: NP_057713.1 (H. sapiens) hypothetical protein LOC51323 [Homo sapiens] |
| 20523 | 190 | AA891842 | | Rattus norvegicus transcribed sequence with weak similarity to protein |
| | | | | ref: NP_057713.1 (H. sapiens) hypothetical protein LOC51323 (Homo sapiens) |
| 17249 | 191 | AA891858 | | Rattus norvegicus transcribed sequence with moderate similarity to protein |
| | | | | sp: O88338 (M. musculus) CADG_MOUSE Cadherin-16 precursor (Kidney-specific |
| | | | | cadherin) (Ksp-cadherin) |
| 16023 | 192 | AA891872 | | Rattus norvegicus transcribed sequence with strong similarity to protein pir: S54876 |
| | | | | (M. musculus) S54876 NAD(P)+ transhydrogenase (B-specific) (EC 1.6.1.1) |
| | | | | precursor-mouse |
| 17779 | 194 | AA891914 | | Rattus norvegicus transcribed sequence with moderate similarity to protein |
| | | | | pir: A47488 (H. sapiens) A47488 aminoacylase (EC 3.5.1.14)-human |
| 1159 | 197 | AA891949 | | Rattus norvegicus transcribed sequences |
| 17630 | 201 | AA892012 | glutamate oxaloacetate transaminase 2 | glutamate oxaloacetate transaminase 2 |
| 13420 | 205 | AA892042 | | Rattus norvegicus transcribed sequence with weak similarity to protein pir: JC2534 |
| | | | | (R. norvegicus) JC2534 RVLG protein-rat |
| 4259 | 207 | AA892123 | ribosomal protein L36 | ribosomal protein L36 |
| 14595 | 208 | AA892128 | | Rattus norvegicus transcribed sequences |
| 16529 | 210 | AA892154 | | Rattus norvegicus transcribed sequence with moderate similarity to protein |
| | | | | pdb: 1LBG (E. coli) B Chain B, Lactose Operon Repressor Bound To 21-Base Pair |
| | | | | Symmetric Operator Dna, Alpha Carbons Only |
| 4482 | 211 | AA892173 | | Rattus norvegicus transcribed sequence |
| 8317 | 212 | AA892234 | | Rattus norvegicus transcribed sequence with strong similarity to protein |
| | | | | ref: NP_079845.1 (M. musculus) microsomal glutathione S-transferase 3 [Mus |
| | | | | musculus] |
| 4484 | 213 | AA892258 | NADPH oxidase 4 | NADPH oxidase 4 |
| 18190 | 215 | AA892280 | | Rattus norvegicus transcribed sequences |
| 17717 | 216 | AA892287 | | Rattus norvegicus transcribed sequence with weak similarity to protein |
| | | | | ref: NP_061123.2 (H. sapiens) G protein-coupled receptor, family C, group 5, |
| | | | | member C, isoform b, precursor; orphan G-protein coupled receptor; retinoic acid |
| | | | | inducible gene 3 protein; retinoic acid responsive gene protein [Homo sapiens] |
| 9027 | 218 | AA892312 | potassium inwardly-rectifying channel, subfamily J, member | potassium inwardly-rectifying channel, subfamily J, member 16 |
| | | | 16 | |
| 13647 | 221 | AA892367 | | Rattus norvegicus transcribed sequence with strong similarity to protein sp: P21531 |
| | | | | (R. norvegicus) RL3_RAT 60S RIBOSOMAL PROTEIN L3 (L4) |
| 820 | 225 | AA892395 | aldolase B | (Rattus norvegicus transcribed sequence with strong similarity to protein |
| | | | | sp: P00884 (R. norvegicus) ALFB_RAT FRUCTOSE-BISPHOSPHATE ALDOLASE |
| | | | | B (LIVER-TYPE ALDOLASE), aldolase B) |
| 12016 | 226 | AA892404 | Na+ dependent glucose transporter 1 | Na+ dependent glucose transporter 1 |
| 21695 | 231 | AA892506 | coronin, actin binding protein 1A | coronin, actin binding protein 1A |
| 4499 | 232 | AA892511 | | Rattus norvegicus transcribed sequence with weak similarity to protein |
| | | | | ref: NP_077053.1 (R. norvegicus) calcium binding protein P22 [Rattus norvegicus] |
| 8599 | 233 | AA892522 | | Rattus norvegicus transcribed sequences |
| 15154 | 234 | AA892532 | protein disulfide isomerase-related protein | protein disulfide isomerase-related protein |
| 12276 | 235 | AA892541 | | Rattus norvegicus transcribed sequences |
| 12275 | 235 | AA892541 | | Rattus norvegicus transcribed sequences |
| 18275 | 239 | AA892572 | | Rattus norvegicus transcribed sequence with strong similarity to protein |
| | | | | ref: NP_079639.1 (M. musculus) RIKEN cDNA 1110001J03 [Mus musculus] |
| 18274 | 239 | AA892572 | | Rattus norvegicus transcribed sequence with strong similarity to protein |
| | | | | ref: NP_079639.1 (M. musculus) RIKEN cDNA 1110001J03 [Mus musculus] |
| 4512 | 240 | AA892578 | | Rattus norvegicus transcribed sequence with strong similarity to protein |
| | | | | ref: NP_116238.1 (H. sapiens) hypothetical protein FLJ14834 [Homo sapiens] |
| 15876 | 241 | AA892582 | aldehyde dehydrogenase family 3, member A1 | aldehyde dehydrogenase family 3, member A1 |
| 17500 | 243 | AA892616 | solute carrier family 13 (sodium-dependent dicarboxylate | solute carrier family 13 (sodium-dependent dicarboxylate transporter), member 3 |
| | | | transporter), member 3 | |
| 23783 | 245 | AA892773 | | Rattus norvegicus transcribed sequence with moderate similarity to protein |
| | | | | pdb: 1LBG (E. coli) B Chain B, Lactose Operon Repressor Bound To 21-Base Pair |
| | | | | Symmetric Operator Dna, Alpha Carbons Only |
| 13542 | 247 | AA892798 | uterine sensitization-associated gene 1 protein | uterine sensitization-associated gene 1 protein |
| 22539 | 248 | AA892799 | | Rattus norvegicus transcribed sequence with weak similarity to protein |
| | | | | ref: NP_113808.1 (R. norvegicus) 3-phosphoglycerate dehydrogenase [Rattus |
| | | | | norvegicus] |
| 15385 | 249 | AA892808 | isocitrate dehydrogenase 3, gamma | isocitrate dehydrogenase 3, gamma |
| 23322 | 252 | AA892821 | aldo-keto reductase family 7, member A2 (aflatoxin | aldo-keto reductase family 7, member A2 (aflatoxin aldehyde reductase) |
| | | | aldehyde reductase) | |
| 12848 | 257 | AA892916 | | Rattus norvegicus Ab2-305 mRNA, complete cds |
| 3853 | 260 | AA892999 | | Rattus norvegicus transcribed sequences |
| 3439 | 261 | AA893000 | | Rattus norvegicus transcribed sequence with strong similarity to protein pir: T00335 |
| | | | | (H. sapiens) T00335 hypothetical protein KIAA0564-human (fragment) |
| 12020 | 262 | AA893035 | HP33 | HP33 |
| 3870 | 266 | AA893147 | | Rattus norvegicus transcribed sequences |
| 548 | 271 | AA893235 | | Rattus norvegicus transcribed sequence with strong similarity to protein sp: Q61585 |
| | | | | (M. musculus) G0S2_MOUSE Putative lymphocyte G0/G1 switch protein 2 (G0S2- |
| | | | | like protein) |
| 17752 | 272 | AA893244 | | Rattus norvegicus transcribed sequences |
| 18967 | 273 | AA893260 | | Rattus norvegicus transcribed sequence with weak similarity to protein |
| | | | | ref: NP_083358.1 (M. musculus) RIKEN cDNA 5830411J07 [Mus musculus] |
| 4242 | 276 | AA893325 | ornithine aminotransferase | ornithine aminotransferase |
| 7505 | 282 | AA893702 | transcobalamin II precursor | transcobalamin II precursor |
| 9084 | 283 | AA893717 | | Rattus norvegicus transcribed sequence with strong similarity to protein |
| | | | | ref: NP_036155.1 (M. musculus) Rac GTPase-activating protein 1 [Mus musculus] |
| 10540 | 286 | AA894027 | | |
| 3895 | 287 | AA894029 | | Rattus norvegicus transcribed sequences |
| 16435 | 290 | AA894174 | | Rattus norvegicus transcribed sequence with strong similarity to protein pir: A31568 |
| | | | | (R. norvegicus) A31568 electron transfer flavoprotein alpha chain precursor-rat |
| 16849 | 292 | AA894298 | membrane metallo endopeptidase | membrane metallo endopeptidase |
| 24329 | 294 | AA899253 | myristoylated alanine rich protein kinase C substrate | myristoylated alanine rich protein kinase C substrate |
| 23778 | 298 | AA899854 | topoisomerase (DNA) 2 alpha | topoisomerase (DNA) 2 alpha |
| 9541 | 300 | AA900505 | rhoB gene | rhoB gene |
| 20711 | 307 | AA924267 | cytochrome P450, 4A1 | cytochrome P450, 4A1 |
| 17157 | 329 | AA926129 | | Rattus norvegicus transcribed sequence with strong similarity to protein |
| | | | | ref: NP_446139.1 (R. norvegicus) schlafen 4 [Rattus norvegicus] |
| 16468 | 330 | AA926137 | | Rattus norvegicus transcribed sequence with strong similarity to protein |
| | | | | ref: NP_079926.1 (M. musculus) RIKEN cDNA 0710008D09 [Mus musculus] |
| 15028 | 336 | AA942685 | cytosolic cysteine dioxygenase 1 | cytosolic cysteine dioxygenase 1 |
| 21696 | 346 | AA944324 | ADP-ribosylation factor 6 | ADP-ribosylation factor 6 |
| 20812 | 356 | AA945611 | ribosomal protein L10 | ribosomal protein L10 |
| 22351 | 361 | AA945867 | v-jun sarcoma virus 17 oncogene homolog (avian) | v-jun sarcoma virus 17 oncogene homolog (avian) |
| 1509 | 435 | AB000507 | aquaporin 7 | aquaporin 7 |
| 17337 | 436 | AB000717 | | |
| 7914 | 439 | AB002584 | beta-alanine-pyruvate aminotransferase | beta-alanine-pyruvate aminotransferase |
| 15703 | 444 | AB009372 | lysophospholipase | lysophospholipase |
| 15662 | 445 | AB010119 | t-complex testis expressed 1 | t-complex testis expressed 1 |
| 4312 | 448 | AB010635 | carboxylesterase 2 (intestine, liver) | carboxylesterase 2 (intestine, liver) |
| 13973 | 449 | AB011679 | tubulin, beta 5 | tubulin, beta 5 |
| 18075 | 454 | AB013455 | solute carrier family 34, member 1 | solute carrier family 34, member 1 |
| 18076 | 454 | AB013455 | solute carrier family 34, member 1 | solute carrier family 34, member 1 |
| 18597 | 455 | AB013732 | UDP-glucose dehydrogeanse | UDP-glucose dehydrogeanse |
| 4234 | 457 | AB016536 | (argininosuccinate lyase, heterogeneous nuclear | (argininosuccinate lyase, heterogeneous nuclear ribonucleoprotein A/B) |
| | | | ribonucleoprotein A/B) | |
| 23625 | 458 | AB017260 | solute carrier family 22, member 5 | solute carrier family 22, member 5 |
| 15243 | 459 | AB017912 | MAD homolog 2 (Drosophila) | MAD homolog 2 (Drosophila) |
| 18070 | 462 | AF003008 | max interacting protein 1 | max interacting protein 1 |
| 7488 | 464 | AF007758 | synuclein, alpha | synuclein, alpha |
| 1183 | 465 | AF013144 | MAP-kinase phosphatase (cpg21) | MAP-kinase phosphatase (cpg21) |
| 16407 | 471 | AF022247 | cubilin | cubilin |
| 25165 | 473 | AF022952 | vascular endothelial growth factor B | vascular endothelial growth factor B |
| 3454 | 477 | AF030091 | cyclin L | cyclin L |
| 23045 | 480 | AF034218 | hyaluronidase 2 | hyaluronidase 2 |
| 8426 | 483 | AF036335 | NonO/p54nrb homolog | NonO/p54nrb homolog |
| 17326 | 484 | AF036548 | Rgc32 protein | Rgc32 protein |
| 17327 | 484 | AF036548 | Rgc32 protein | Rgc32 protein |
| 22603 | 487 | AF044574 | 2-4-dienoyl-Coenzyme A reductase 2, peroxisomal | 2-4-dienoyl-Coenzyme A reductase 2, peroxisomal |
| 20864 | 488 | AF045464 | aflatoxin B1 aldehyde reductase | aflatoxin B1 aldehyde reductase |
| 10241 | 489 | AF048687 | UDP-Gal:betaGlcNAc beta 1,4-galactosyltransferase, | UDP-Gal:betaGlcNAc beta 1,4-galactosyltransferase, polypeptide 6 |
| | | | polypeptide 6 | |
| 117 | 490 | AF049239 | sodium channel, voltage-gated, type 8, alpha polypeptide | sodium channel, voltage-gated, type 8, alpha polypeptide |
| 16649 | 491 | AF051895 | annexin 5 | annexin 5 |
| 985 | 492 | AF053312 | small inducible cytokine subfamily A20 | small inducible cytokine subfamily A20 |
| 4011 | 496 | AF056333 | cytochrome P450, subfamily 2E, polypeptide 1 | cytochrome P450, subfamily 2E, polypeptide 1 |
| 1104 | 497 | AF058714 | solute carrier family 13, member 2 | solute carrier family 13, member 2 |
| 4589 | 498 | AF062389 | kidney-specific protein (KS) | kidney-specific protein (KS) |
| 16007 | 499 | AF062594 | nucleosome assembly protein 1-like 1 | nucleosome assembly protein 1-like 1 |
| 16444 | 502 | AF065438 | peptidylprolyl isomerase C-associated protein | peptidylprolyl isomerase C-associated protein |
| 16155 | 503 | AF068860 | defensin beta 1 | defensin beta 1 |
| 25198 | 504 | AF069782 | Nopp140 associated protein | Nopp140 associated protein |
| 744 | 506 | AF076856 | espin | espin |
| 5496 | 507 | AF080468 | glucose-6-phosphatase, transport protein 1 | glucose-6-phosphatase, transport protein 1 |
| 5497 | 507 | AF080468 | glucose-6-phosphatase, transport protein 1 | glucose-6-phosphatase, transport protein 1 |
| 25204 | 508 | AF080507 | | |
| 17535 | 513 | AF090306 | retinoblastoma binding protein 7 | retinoblastoma binding protein 7 |
| 16156 | 514 | AF093536 | defensin beta 1 | defensin beta 1 |
| 4723 | 515 | AF093773 | malate dehydrogenase 1 | malate dehydrogenase 1 |
| 2368 | 516 | AF095741 | Mg87 protein | Mg87 protein |
| 2367 | 516 | AF095741 | Mg87 protein | Mg87 protein |
| 6554 | 517 | AF097723 | plasma glutamate carboxypeptidase | plasma glutamate carboxypeptidase |
| 15848 | 520 | AI007820 | | Rattus norvegicus heat shock protein 90 beta mRNA, partial sequence |
| 15849 | 523 | AI008074 | | Rattus norvegicus heat shock protein 90 beta mRNA, partial sequence |
| 15434 | 531 | AI008836 | high mobility group box 2 | high mobility group box 2 |
| 15097 | 535 | AI009405 | insulin-like growth factor binding protein 3 | insulin-like growth factor binding protein 3 |
| 23362 | 537 | AI009605 | Ras homolog enriched in brain | Ras homolog enriched in brain |
| 17473 | 544 | AI009806 | dynein, cytoplasmic, light chain 1 | dynein, cytoplasmic, light chain 1 |
| 15616 | 570 | AI011998 | dnaJ homolog, subfamily b, member 9 | dnaJ homolog, subfamily b, member 9 |
| 20817 | 582 | AI012589 | (glutathione S-transferase, pi 2, glutathione-S-transferase, | (glutathione S-transferase, pi 2, glutathione-S-transferase, pi 1) |
| | | | pi 1) | |
| 18713 | 585 | AI012604 | eukaryotic initiation factor 5 (eIF-5) | eukaryotic initiation factor 5 (eIF-5) |
| 21950 | 599 | AI013861 | 3-hydroxyisobutyrate dehydrogenase | 3-hydroxyisobutyrate dehydrogenase |
| 815 | 603 | AI014087 | ribosomal protein S26 | ribosomal protein S26 |
| 15247 | 606 | AI014169 | upregulated by 1,25-dihydroxyvitamin D-3 | upregulated by 1,25-dihydroxyvitamin D-3 |
| 21682 | 635 | AI045030 | CCAAT/enhancerbinding, protein (C/EBP) delta | CCAAT/enhancerbinding, protein (C/EBP) delta |
| 20802 | 655 | AI059508 | transketolase | transketolase |
| 15190 | 705 | AI102562 | Metallothionein | Metallothionein |
| 23837 | 707 | AI102620 | | Rattus norvegicus transcribed sequences |
| 4449 | 712 | AI102838 | Isovaleryl Coenzyme A dehydrogenase | Isovaleryl Coenzyme A dehydrogenase |
| 15861 | 714 | AI102868 | | Rattus norvegicus phosphoserine aminotransferase mRNA, complete cds |
| 16918 | 715 | AI103074 | ribosomal protein S12 | ribosomal protein S12 |
| 20833 | 731 | AI104035 | | Rattus norvegicus transcribed sequence with strong similarity to protein |
| | | | | ref: NP_079904.1 (M. musculus) RIKEN cDNA 2010000G05 [Mus musculus] |
| 18077 | 740 | AI105198 | solute carrier family 34, member 1 | solute carrier family 34, member 1 |
| 23660 | 747 | AI105448 | hydroxysteroid 11-beta dehydrogenase 1 | hydroxysteroid 11-beta dehydrogenase 1 |
| 20919 | 756 | AI112516 | zinc finger protein 36, C3H type-like 1 | zinc finger protein 36, C3H type-like 1 |
| 20920 | 763 | AI136891 | zinc finger protein 36, C3H type-like 1 | zinc finger protein 36, C3H type-like 1 |
| 16510 | 771 | AI137583 | | |
| 17160 | 792 | AI169370 | alpha-tubulin | alpha-tubulin |
| 8749 | 799 | AI169802 | ferritin, heavy polypeptide 1 | ferritin, heavy polypeptide 1 |
| 18687 | 804 | AI170568 | dodecenoyl-coenzyme A delta isomerase | dodecenoyl-coenzyme A delta isomerase |
| 21975 | 827 | AI172247 | xanthine dehydrogenase | xanthine dehydrogenase |
| 21842 | 828 | AI172293 | sterol-C4-methyl oxidase-like | sterol-C4-methyl oxidase-like |
| 15191 | 840 | AI176456 | | Rattus norvegicus transcribed sequence with strong similarity to protein sp: P04355 |
| | | | | (R. norvegicus) MT2_RAT METALLOTHIONEIN-II (MT-II) |
| 20717 | 844 | AI176504 | glutaminase | glutaminase |
| 16518 | 845 | AI176546 | heat shock protein 86 | heat shock protein 86 |
| 3431 | 846 | AI176595 | Cathepsin L | Cathepsin L |
| 17570 | 863 | AI177683 | | Rattus norvegicus mRNA for hnRNP protein, partial |
| 15259 | 870 | AI178135 | complement component 1, q subcomponent binding protein | complement component 1, q subcomponent binding protein |
| 17563 | 875 | AI178750 | eukaryotic translation elongation factor 2 | eukaryotic translation elongation factor 2 |
| 17829 | 884 | AI179576 | hemoglobin beta chain complex | hemoglobin beta chain complex |
| 16081 | 888 | AI179610 | Heme oxygenase | Heme oxygenase |
| 1474 | 903 | AI228548 | | Rattus norvegicus transcribed sequence with strong similarity to protein sp: P35467 |
| | | | | (R. norvegicus) S10A_RAT S-100 protein, alpha chain |
| 15296 | 907 | AI228738 | (FK506 binding protein 2, FK506-binding protein 1a) | (FK506 binding protein 2, FK506-binding protein 1a) |
| 17448 | 912 | AI229637 | MYB binding protein 1a | MYB binding protein 1a |
| 15862 | 921 | AI230228 | | Rattus norvegicus phosphoserine aminotransferase mRNA, complete cds |
| 17196 | 942 | AI231519 | sialyltransferase 7c | sialyltransferase 7c |
| 8212 | 945 | AI231807 | ferritin light chain 1 | ferritin light chain 1 |
| 20702 | 946 | AI231821 | stathmin 1 | stathmin 1 |
| 573 | 949 | AI232087 | hydroxyacid oxidase (glycolate oxidase) 3 | hydroxyacid oxidase (glycolate oxidase) 3 |
| 409 | 953 | AI232268 | low density lipoprotein receptor-related protein associated | low density lipoprotein receptor-related protein associated protein 1 |
| | | | protein 1 | |
| 4574 | 968 | AI233216 | glutamate dehydrogenase 1 | glutamate dehydrogenase 1 |
| 17764 | 985 | AI234604 | heat shock protein 8 | heat shock protein 8 |
| 15468 | 997 | AI235364 | ribosomal protein S15a | ribosomal protein S15a |
| 15850 | 1018 | AI236795 | | Rattus norvegicus heat shock protein 90 beta mRNA, partial sequence |
| 11692 | 1027 | AI638982 | sulfotransferase family, cytosolic, 1C, member 2 | sulfotransferase family, cytosolic, 1C, member 2 |
| 19997 | 1031 | AI639043 | | Rattus norvegicus transcribed sequences |
| 10071 | 1032 | AI639058 | | Rattus norvegicus transcribed sequence with strong similarity to protein |
| | | | | ref: NP_075371.1 (M. musculus) Nedd4 WW binding# protein 4; Nedd4 WW- |
| | | | | binding protein 4 [Mus musculus] |
| 16676 | 1033 | AI639082 | mini chromosome maintenance deficient 6 (S. cerevisiae) | mini chromosome maintenance deficient 6 (S. cerevisiae) |
| 19952 | 1034 | AI639108 | | Rattus norvegicus transcribed sequences |
| 15379 | 1037 | AI639162 | | Rattus norvegicus transcribed sequences |
| 25907 | 1038 | AI639167 | | Rattus norvegicus transcribed sequences |
| 19002 | 1043 | AI639465 | ring finger protein 28 | ring finger protein 28 |
| 19943 | 1045 | AI639479 | | Rattus norvegicus transcribed sequence with strong similarity to protein |
| | | | | prf: 2008147A (R. norvegicus) 2008147A protein RAKb [Rattus norvegicus] |
| 20082 | 1046 | AI639488 | | Rattus norvegicus transcribed sequence with strong similarity to protein pir: A42772 |
| | | | | (R. norvegicus) A42772 mdm2 protein-rat (fragments) |
| 1203 | 1049 | AJ000485 | cytoplasmic linker 2 | cytoplasmic linker 2 |
| 12422 | 1053 | AJ006971 | Death-associated like kinase | Death-associated like kinase |
| 12423 | 1053 | AJ006971 | Death-associated like kinase | Death-associated like kinase |
| 25247 | 1054 | AJ011608 | DNA primase, p49 subunit | DNA primase, p49 subunit |
| 20404 | 1055 | AJ011656 | claudin 3 | claudin 3 |
| 18956 | 1059 | D00512 | acetyl-coenzyme A acetyltransferase 1 | acetyl-coenzyme A acetyltransferase 1 |
| 15409 | 1060 | D00569 | 2,4-dienoyl CoA reductase 1, mitochondrial | 2,4-dienoyl CoA reductase 1, mitochondrial |
| 15408 | 1060 | D00569 | 2,4-dienoyl CoA reductase 1, mitochondrial | 2,4-dienoyl CoA reductase 1, mitochondrial |
| 4615 | 1061 | D00680 | glutathione peroxidase 3 | glutathione peroxidase 3 |
| 18686 | 1062 | D00729 | dodecenoyl-coenzyme A delta isomerase | (Rattus norvegicus mRNA for delta3, delta2-enoyl-CoA isomerase, complete cds, |
| | | | | dodecenoyl-coenzyme A delta isomerase) |
| 2554 | 1063 | D00913 | intercellular adhesion molecule 1 | intercellular adhesion molecule 1 |
| 1306 | 1065 | D10262 | choline kinase | choline kinase |
| 3254 | 1070 | D10756 | proteasome (prosome, macropain) subunit, alpha type 5 | proteasome (prosome, macropain) subunit, alpha type 5 |
| 4003 | 1071 | D10757 | proteosome (prosome, macropain) subunit, beta type 9 | proteosome (prosome, macropain) subunit, beta type 9 (large multifunctional |
| | | | (large multifunctional protease 2) | protease 2) |
| 23109 | 1072 | D10854 | aldo-keto reductase family 1, member A1 | aldo-keto reductase family 1, member A1 |
| 24428 | 1074 | D13126 | neural visinin-like Ca2+-binding protein type 3 | neural visinin-like Ca2+-binding protein type 3 |
| 15281 | 1075 | D13623 | | |
| 25257 | 1075 | D13623 | | |
| 1214 | 1076 | D13871 | (nuclear receptor subfamily 1, group H, member 4, solute | (nuclear receptor subfamily 1, group H, member 4, solute carrier family 2, member |
| | | | carrier family 2, member 5) | 5) |
| 18958 | 1077 | D13921 | acetyl-coenzyme A acetyltransferase 1 | acetyl-coenzyme A acetyltransferase 1 |
| 18727 | 1078 | D13978 | argininosuccinate lyase | argininosuccinate lyase |
| 11434 | 1079 | D14014 | cyclin D1 | cyclin D1 |
| 18246 | 1081 | D14441 | brain acidic membrane protein | brain acidic membrane protein |
| 16768 | 1083 | D16478 | hydroxyacyl-Coenzyme A dehydrogenase/3-ketoacyl- | hydroxyacyl-Coenzyme A dehydrogenase/3-ketoacyl-Coenzyme A hiolase/enoyl- |
| | | | Coenzyme A hiolase/enoyl-Coenzyme A hydratase | Coenzyme A hydratase (trifunctional protein), alpha subunit |
| | | | (trifunctional protein), alpha subunit | |
| 18452 | 1085 | D17370 | CTL target antigen | CTL target antigen |
| 18453 | 1085 | D17370 | CTL target antigen | CTL target antigen |
| 16683 | 1086 | D17445 | Tyrosine 3-monooxygenase/tryptophan 5-monooxygenase | Tyrosine 3-monooxygenase/tryptophan 5-monooxygenase activation protein, eta |
| | | | activation protein, eta polypeptide | polypeptide |
| 24885 | 1088 | D25224 | laminin receptor 1 (67 kD, ribosomal protein SA) | laminin receptor 1 (67 kD, ribosomal protein SA) |
| 20493 | 1090 | D28339 | 3-hydroxyanthranilate 3,4-dioxygenase | 3-hydroxyanthranilate 3,4-dioxygenase |
| 16610 | 1091 | D28557 | cold shock domain protein A | cold shock domain protein A |
| 16681 | 1095 | D37920 | squalene epoxidase | squalene epoxidase |
| 5492 | 1097 | D38061 | UDP glycosyltransferase 1 family, polypeptide A6 | UDP glycosyltransferase 1 family, polypeptide A6 |
| 18028 | 1098 | D38062 | UDP glycosyltransferase 1 family, polypeptide A7 | UDP glycosyltransferase 1 family, polypeptide A7 |
| 1354 | 1099 | D38065 | UDP glycosyltransferase 1 family, polypeptide A1 | UDP glycosyltransferase 1 family, polypeptide A1 |
| 755 | 1100 | D38448 | diacylglycerol kinase, gamma | diacylglycerol kinase, gamma |
| 25290 | 1102 | D42148 | growth arrest specific 6 | growth arrest specific 6 |
| 20494 | 1103 | D44494 | 3-hydroxyanthranilate 3,4-dioxygenase | 3-hydroxyanthranilate 3,4-dioxygenase |
| 20801 | 1104 | D44495 | apurinic/apyrimidinic endonuclease 1 | apurinic/apyrimidinic endonuclease 1 |
| 18750 | 1105 | D45250 | protease (prosome, macropain) 28 subunit, beta | protease (prosome, macropain) 28 subunit, beta |
| 16354 | 1108 | D50564 | mercaptopyruvate sulfurtransferase | mercaptopyruvate sulfurtransferase |
| 770 | 1112 | D83044 | solute carrier family 22, member 2 | solute carrier family 22, member 2 |
| 15126 | 1113 | D83796 | (UDP glycosyltransferase 1 family, polypeptide A1, UDP | (UDP glycosyltransferase 1 family, polypeptide A1, UDP glycosyltransferase 1 |
| | | | glycosyltransferase 1 family, polypeptide A6, UDP | family, polypeptide A6, UDP glycosyltransferase 1 family, polypeptide A7, UDP- |
| | | | glycosyltransferase 1 family, polypeptide A7, UDP- | glucuronosyltransferase 1A8) |
| | | | glucuronosyltransferase 1A8) | |
| 17554 | 1115 | D85100 | solute carrier family 27 (fatty acid transporter), member 32 | solute carrier family 27 (fatty acid transporter), member 32 |
| 13005 | 1116 | D85189 | fatty acid Coenzyme A ligase, long chain 4 | fatty acid Coenzyme A ligase, long chain 4 |
| 16448 | 1117 | D86297 | aminolevulinic acid synthase 2 | aminolevulinic acid synthase 2 |
| 15297 | 1118 | D86641 | (FK506 binding protein 2, FK506-binding protein 1a) | (FK506 binding protein 2, FK506-binding protein 1a) |
| 945 | 1120 | D88666 | phosphatidylserine-specific phospholipase A1 | phosphatidylserine-specific phospholipase A1 |
| 25315 | 1121 | D89730 | | |
| 3987 | 1122 | D90258 | proteasome (prosome, macropain) subunit, alpha type 3 | proteasome (prosome, macropain) subunit, alpha type 3 |
| 1921 | 1123 | E01524 | P450 (cytochrome) oxidoreductase | P450 (cytochrome) oxidoreductase |
| 25024 | 1124 | E03229 | cytosolic cysteine dioxygenase 1 | cytosolic cysteine dioxygenase 1 |
| 19824 | 1125 | E13557 | cysteine-sulfinate decarboxylase | cysteine-sulfinate decarboxylase |
| 4361 | 1127 | H31839 | BCL2-antagonist/killer 1 | BCL2-antagonist/killer 1 |
| 21011 | 1128 | H32189 | glutathione S-transferase, mu 1 | glutathione S-transferase, mu 1 |
| 4386 | 1129 | H33093 | | Rattus norvegicus transcribed sequences |
| 1301 | 1132 | J02585 | stearoyl-Coenzyme A desaturase 1 | stearoyl-Coenzyme A desaturase 1 |
| 21012 | 1133 | J02592 | Glutathione-S-transferase, mu type 2 (Yb2) | Glutathione-S-transferase, mu type 2 (Yb2) |
| 15124 | 1134 | J02612 | (UDP glycosyltransferase 1 family, polypeptide, UDP | (UDP glycosyltransferase 1 family, polypeptide A1, UDP glycosyltransferase 1 |
| | | | glycosyltransferase 1 family, polypeptide A6, UDP | family, polypeptide A6, UDP glycosyltransferase 1 family, polypeptide A7, UDP- |
| | | | glycosyltransferase 1 family, polypeptide A7, UDP- | glucuronosyltransferase 1A8) |
| | | | glucuronosyltransferase 1A8) | |
| 1174 | 1136 | J02657 | Cytochrome P450, subfamily IIC (mephenytoin 4- | Cytochrome P450, subfamily IIC (mephenytoin 4-hydroxylase) |
| | | | hydroxylase) | |
| 16080 | 1138 | J02722 | Heme oxygenase | Heme oxygenase |
| 23699 | 1139 | J02749 | acetyl-Coenzyme A acyltransferase 1 (peroxisomal 3- | acetyl-Coenzyme A acyltransferase 1 (peroxisomal 3-oxoacyl-Coenzyme A |
| | | | oxoacyl-Coenzyme A thiolase) | thiolase) |
| 23698 | 1139 | J02749 | acetyl-Coenzyme A acyltransferase 1 (peroxisomal 3- | acetyl-Coenzyme A acyltransferase 1 (peroxisomal 3-oxoacyl-Coenzyme A |
| | | | oxoacyl-Coenzyme A thiolase) | thiolase) |
| 16148 | 1140 | J02752 | acyl-coA oxidase | acyl-coA oxidase |
| 1514 | 1142 | J02780 | Tropomycin 4 | Tropomycin 4 |
| 21078 | 1143 | J02791 | acetyl-coenzyme A dehydrogenase, medium chain | acetyl-coenzyme A dehydrogenase, medium chain |
| 21013 | 1144 | J02810 | glutathione S-transferase, mu 1 | glutathione S-transferase, mu 1 |
| 17284 | 1145 | J02827 | branched chain keto acid dehydrogenase subunit E1, alpha | branched chain keto acid dehydrogenase subunit E1, alpha polypeptide |
| | | | polypeptide | |
| 17285 | 1145 | J02827 | branched chain keto acid dehydrogenase subunit E1, alpha | branched chain keto acid dehydrogenase subunit E1, alpha polypeptide |
| | | | polypeptide | |
| 1762 | 1147 | J03179 | D site albumin promoter binding protein | D site albumin promoter binding protein |
| 1763 | 1147 | J03179 | D site albumin promoter binding protein | D site albumin promoter binding protein |
| 13479 | 1149 | J03481 | quinoid dihydropteridine reductase | quinoid dihydropteridine reductase |
| 13480 | 1149 | J03481 | quinoid dihydropteridine reductase | quinoid dihydropteridine reductase |
| 14997 | 1150 | J03572 | alkaline phosphatase, tissue-nonspecific | alkaline phosphatase, tissue-nonspecific |
| 16948 | 1151 | J03588 | Guanidinoacetate methyltransferase | Guanidinoacetate methyltransferase |
| 15017 | 1153 | J03752 | microsomal glutathione S-transferase 1 | microsomal glutathione S-transferase 1 |
| 17394 | 1156 | J03969 | nucleophosmin 1 | nucleophosmin 1 |
| 7784 | 1157 | J04591 | Dipeptidyl peptidase 4 | Dipeptidyl peptidase 4 |
| 23524 | 1158 | J04792 | | |
| 17393 | 1159 | J04943 | nucleophosmin 1 | nucleophosmin 1 |
| 6780 | 1160 | J05029 | acetyl-Coenzyme A dehydrogenase, long-chain | acetyl-Coenzyme A dehydrogenase, long-chain |
| 4451 | 1161 | J05031 | Isovaleryl Coenzyme A dehydrogenase | Isovaleryl Coenzyme A dehydrogenase |
| 4450 | 1161 | J05031 | Isovaleryl Coenzyme A dehydrogenase | Isovaleryl Coenzyme A dehydrogenase |
| 15125 | 1162 | J05132 | (UDP glycosyltransferase 1 family, polypeptide A1, UDP | (UDP glycosyltransferase 1 family, polypeptide A1, UDP glycosyltransferase 1 |
| | | | glycosyltransferase 1 family, polypeptide A6, UDP | family, polypeptide A6, UDP glycosyltransferase 1 family, polypeptide A7, UDP- |
| | | | glycosyltransferase 1 family, polypeptide A7, UDP- | glucuronosyltransferase 1A8) |
| | | | glucuronosyltransferase 1A8) | |
| 1247 | 1163 | J05181 | glutamate-cysteine ligase catalytic subunit | glutamate-cysteine ligase catalytic subunit |
| 1977 | 1164 | J05470 | Carnitine palmitoyltransferase 2 | Carnitine palmitoyltransferase 2 |
| 24563 | 1167 | J05592 | protein phosphatase 1, regulatory (inhibitor) subunit 1A | protein phosphatase 1, regulatory (inhibitor) subunit 1A |
| 24564 | 1167 | J05592 | protein phosphatase 1, regulatory (inhibitor) subunit 1A | protein phosphatase 1, regulatory (inhibitor) subunit 1A |
| 18989 | 1168 | K00136 | glutathione-S-transferase, alpha type2 | glutathione-S-transferase, alpha type2 |
| 634 | 1170 | K01932 | glutathione S-transferase, alpha 1 | glutathione S-transferase, alpha 1 |
| 20149 | 1172 | K03243 | | |
| 17758 | 1173 | K03249 | enoyl-Coenzyme A, hydratase/3-hydroxyacyl Coenzyme A | enoyl-Coenzyme A, hydratase/3-hydroxyacyl Coenzyme A dehydrogenase |
| | | | dehydrogenase | |
| 10878 | 1174 | K03250 | ribosomal protein S11 | ribosomal protein S11 |
| 20865 | 1175 | L00117 | Elastase 1 | Elastase 1 |
| 1894 | 1176 | L03201 | cathepsin S | cathepsin S |
| 15411 | 1178 | L07736 | carnitine palmitoyltransferase 1 | carnitine palmitoyltransferase 1 |
| 617 | 1179 | L08831 | Glucose-dependent insulinotropic peptide | Glucose-dependent insulinotropic peptide |
| 3549 | 1181 | L11319 | signal peptidase complex 18 kD | signal peptidase complex 18 kD |
| 22412 | 1184 | L13619 | growth response protein (CL-6) | growth response protein (CL-6) |
| 22413 | 1184 | L13619 | growth response protein (CL-6) | growth response protein (CL-6) |
| 109 | 1187 | L14004 | Polymeric immunoglobulin receptor | Polymeric immunoglobulin receptor |
| 1475 | 1190 | L16764 | heat shock 70 kD protein 1A | heat shock 70 kD protein 1A |
| 24770 | 1191 | L19031 | solute carrier family 21, member 1 | solute carrier family 21, member 1 |
| 4749 | 1192 | L19998 | sulfotransferase family 1A, phenol-preferring, member 1 | sulfotransferase family 1A, phenol-preferring, member 1 |
| 4748 | 1192 | L19998 | sulfotransferase family 1A, phenol-preferring, member 1 | sulfotransferase family 1A, phenol-preferring, member 1 |
| 10248 | 1193 | L23148 | Inhibitor of DNA binding 1, helix-loop-helix protein (splice | Inhibitor of DNA binding 1, helix-loop-helix protein (splice variation) |
| | | | variation) | |
| 43 | 1194 | L23413 | solute carrier family 26 (sulfate transporter), member 1 | solute carrier family 26 (sulfate transporter), member 1 |
| 22411 | 1198 | L26292 | Kruppel-like factor 4 (gut) | Kruppel-like factor 4 (gut) |
| 15872 | 1201 | L28135 | solute carrier family 2, member 2 | solute carrier family 2, member 2 |
| 15112 | 1205 | L34049 | low density lipoprotein receptor-related protein 2 | low density lipoprotein receptor-related protein 2 |
| 1321 | 1206 | L37333 | glucose-6-phosphatase, catalytic | glucose-6-phosphatase, catalytic |
| 13682 | 1207 | L38482 | | |
| 6406 | 1208 | L38615 | glutathione synthetase | glutathione synthetase |
| 1427 | 1209 | L38644 | karyopherin, beta 1 | karyopherin, beta 1 |
| 11955 | 1212 | L48209 | cytochrome c oxidase, subunit VIIIa | cytochrome c oxidase, subunit VIIIa |
| 1920 | 1213 | M10068 | P450 (cytochrome) oxidoreductase | P450 (cytochrome) oxidoreductase |
| 15741 | 1214 | M11670 | Catalase | Catalase |
| 15189 | 1215 | M11794 | Metallothionein | Metallothionein |
| 17765 | 1216 | M11942 | heat shock protein 8 | heat shock protein 8 |
| 17502 | 1217 | M12156 | heterogeneous nuclear ribonucleoprotein A1 | heterogeneous nuclear ribonucleoprotein A1 |
| 6055 | 1218 | M12337 | Phenylalanine hydroxylase | Phenylalanine hydroxylase |
| 4254 | 1219 | M12450 | Group-specific component (vitamin D-binding protein) | Group-specific component (vitamin D-binding protein) |
| 7064 | 1220 | M12919 | aldolase A | aldolase A |
| 1466 | 1222 | M14050 | heat shock 70 kD protein 5 | heat shock 70 kD protein 5 |
| 455 | 1225 | M15474 | tropomyosin 1, alpha | tropomyosin 1, alpha |
| 19255 | 1227 | M15562 | | Rat MHC class II RT1.u-D-alpha chain mRNA, 3′ end |
| 19256 | 1227 | M15562 | | Rat MHC class II RT1.u.D-alpha chain mRNA, 3′ end |
| 20809 | 1229 | M17069 | Calmodulin 2 (phosphorylase kinase, delta) | Calmodulin 2 (phosphorylase kinase, delta) |
| 25405 | 1230 | M18330 | protein kinase C, delta | protein kinase C, delta |
| 24567 | 1234 | M19304 | prolactin receptor | prolactin receptor |
| 17198 | 1235 | M19647 | kallikrein 1 | kallikrein 1 |
| 17197 | 1235 | M19647 | | |
| 4010 | 1237 | M20131 | | |
| 20481 | 1240 | M22631 | Propionyl Coenzyme A carboxylase, alpha polypeptide | Propionyl Coenzyme A carboxylase, alpha polypeptide |
| 46 | 1242 | M23697 | Plasminogen activator, tissue | Plasminogen activator, tissue |
| 18619 | 1244 | M24324 | RT1 class lb gene | RT1 class lb gene |
| 1540 | 1246 | M25073 | alanyl (membrane) aminopeptidase | alanyl (membrane) aminopeptidase |
| 17541 | 1247 | M26125 | epoxide hydrolase 1 | epoxide hydrolase 1 |
| 23225 | 1249 | M27467 | cytochrome oxidase subunit VIc | cytochrome oxidase subunit VIc |
| 11956 | 1250 | M28255 | cytochrome c oxidase, subunit VIIIa | cytochrome c oxidase, subunit VIIIa |
| 17105 | 1251 | M29358 | ribosomal protein S6 | ribosomal protein S6 |
| 14346 | 1252 | M31109 | UDP-glucuronosyltransferase 2B3 precursor, microsomal | UDP-glucuronosyltransferase 2B3 precursor, microsomal |
| 1814 | 1253 | M31174 | thyroid hormone receptor alpha | thyroid hormone receptor alpha |
| 18502 | 1254 | M31178 | calbindin 1 | calbindin 1 |
| 18501 | 1254 | M31178 | calbindin 1 | calbindin 1 |
| 20868 | 1256 | M32062 | Fc receptor, IgG, low affinity III | Fc receptor, IgG, low affinity III |
| 20869 | 1256 | M32062 | Fc receptor, IgG, low affinity III | Fc receptor, IgG, low affinity III |
| 20298 | 1257 | M32783 | | |
| 15580 | 1258 | M33648 | 3-hydroxy-3-methylglutaryl-Coenzyme A synthase 2 | 3-hydroxy-3-methylglutaryl-Coenzyme A synthase 2 |
| 11755 | 1259 | M33746 | UDP-glucuronosyltransferase 2 family, member 5 | UDP-glucuronosyltransferase 2 family, member 5 |
| 20126 | 1263 | M34253 | Interferon regulatory factor 1 | Interferon regulatory factor 1 |
| 24590 | 1264 | M35299 | serine protease inhibitor, Kazal type 1 | serine protease inhibitor, Kazal type 1 |
| 20699 | 1265 | M35601 | Fibrinogen, A alpha polypeptide | Fibrinogen, A alpha polypeptide |
| 20700 | 1265 | M35601 | Fibrinogen, A alpha polypeptide | Fibrinogen, A alpha polypeptide |
| 17661 | 1267 | M37584 | H2A histone family, member Z | H2A histone family, member Z |
| 9109 | 1269 | M38135 | Cathepsin H | Cathepsin H |
| 13723 | 1272 | M55534 | crystallin, alpha B | crystallin, alpha B |
| 4467 | 1274 | M57664 | creatine kinase, brain | creatine kinase, brain |
| 20713 | 1275 | M57718 | cytochrome P450, 4A1 | cytochrome P450, 4A1 |
| 25057 | 1277 | M58495 | | |
| 12606 | 1281 | M59861 | 10-formyltetrahydrofolate dehydrogenase | 10-formyltetrahydrofolate dehydrogenase |
| 17378 | 1284 | M62388 | ubiquitin conjugating enzyme | ubiquitin conjugating enzyme |
| 14956 | 1286 | M64301 | mitogen-activated protein kinase 6 | mitogen-activated protein kinase 6 |
| 14957 | 1286 | M64301 | mitogen-activated protein kinase 6 | mitogen-activated protein kinase 6 |
| 19825 | 1288 | M64755 | cysteine-sulfinate decarboxylase | cysteine-sulfinate decarboxylase |
| 17301 | 1292 | M69246 | serine (or cysteine) proteinase inhibitor, clade H, member 1 | serine (or cysteine) proteinase inhibitor, clade H, member 1 |
| 24648 | 1294 | M74054 | angiotensin receptor 1a | angiotensin receptor 1a |
| 20405 | 1295 | M74067 | claudin 3 | claudin 3 |
| 240 | 1297 | M75153 | RAB11a, member RAS oncogene family | RAB11a, member RAS oncogene family |
| 23961 | 1298 | M77694 | fumarylacetoacetate hydrolase | fumarylacetoacetate hydrolase |
| 1622 | 1300 | M80804 | solute carrier family 3, member 1 | solute carrier family 3, member 1 |
| 24843 | 1301 | M80826 | trefoil factor 3 | trefoil factor 3 |
| 5733 | 1303 | M81855 | (ATP-binding cassette, sub-family B (MDR/TAP), member | (ATP-binding cassette, sub-family B (MDR/TAP), member 1A, P- |
| | | | 1A, P-glycoprotein/multidrug resistance 1) | glycoprotein/multidrug resistance 1) |
| 17149 | 1304 | M83107 | Transgelin (Smooth muscle 22 protein) | Transgelin (Smooth muscle 22 protein) |
| 17150 | 1304 | M83107 | Transgelin (Smooth muscle 22 protein) | Transgelin (Smooth muscle 22 protein) |
| 4198 | 1305 | M83143 | Sialyltransferase 1 (beta-galactoside alpha-2,6- | Sialyltransferase 1 (beta-galactoside alpha-2,6-sialytransferase) |
| | | | sialytransferase) | |
| 4199 | 1305 | M83143 | Sialyltransferase 1 (beta-galactoside alpha-2,6- | Sialyltransferase 1 (beta-galactoside alpha-2,6-sialytransferase) |
| | | | sialytransferase) | |
| 24651 | 1306 | M83678 | RAB13 | RAB13 |
| 21882 | 1308 | M83740 | 6-pyruvoyl-tetrahydropterin synthase/dimerization cofactor | 6-pyruvoyl-tetrahydropterin synthase/dimerization cofactor of hepatocyte nuclear |
| | | | of hepatocyte nuclear factor 1 alpha | factor 1 alpha |
| 23445 | 1310 | M84719 | Flavin-containing monooxygenase 1 | Flavin-containing monooxygenase 1 |
| 24438 | 1311 | M85183 | angiotensin/vasopressin receptor | angiotensin/vasopressin receptor |
| 24496 | 1312 | M85300 | solute carrier family 9, member 3 | solute carrier family 9, member 3 |
| 16895 | 1313 | M86240 | fructose-1,6-biphosphatase 1 | fructose-1,6-biphosphatase 1 |
| 7872 | 1315 | M86912 | | |
| 291 | 1316 | M88347 | Cystathionine beta synthase | Cystathionine beta synthase |
| 24615 | 1318 | M89646 | ribosomal protein S24 | ribosomal protein S24 |
| 25460 | 1319 | M89945 | farensyl diphosphate synthase | farensyl diphosphate synthase |
| 11153 | 1320 | M91652 | glutamine synthetase 1 | glutamine synthetase 1 |
| 25467 | 1321 | M93297 | ornithine aminotransferase | ornithine aminotransferase |
| 25468 | 1324 | M94918 | hemoglobin beta chain complex | hemoglobin beta chain complex |
| 25469 | 1325 | M94919 | | |
| 1976 | 1326 | M95493 | guanylate cyclase activator 2A | guanylate cyclase activator 2A |
| 16449 | 1327 | M95591 | farnesyl diphosphate farnesyl transferase 1 | farnesyl diphosphate farnesyl transferase 1 |
| 16450 | 1327 | M95591 | farnesyl diphosphate farnesyl transferase 1 | farnesyl diphosphate farnesyl transferase 1 |
| 729 | 1328 | M95762 | solute carrier family 6 (neurotransmitter transporter, | solute carrier family 6 (neurotransmitter transporter, GABA), member 13 |
| | | | GABA), member 13 | |
| 1678 | 1331 | M96674 | glucagon receptor | glucagon receptor |
| 1508 | 1332 | M97662 | ureidopropionase, beta | ureidopropionase, beta |
| 23708 | 1335 | NM_013113 | ATPase Na+/K+ transporting beta 1 polypeptide | ATPase Na+/K+ transporting beta 1 polypeptide |
| 754 | 1336 | NM_013126 | diacylglycerol kinase, gamma | diacylglycerol kinase, gamma |
| 13938 | 1339 | NM_017212 | microtubule-associated protein tau | microtubule-associated protein tau |
| 1729 | 1342 | NM_019147 | jagged 1 | jagged 1 |
| 15201 | 1349 | NM_031093 | | |
| 18008 | 1350 | NM_031588 | neuregulin 1 | neuregulin 1 |
| 16726 | 1352 | NM_031855 | Ketohexokinase | Ketohexokinase |
| 23709 | 1356 | NM_138532 | (ATPase Na+/K+ transporting beta 1 polypeptide, NME7) | (ATPase Na+/K+ transporting beta 1 polypeptide, NME7) |
| 20795 | 1360 | NM_175761 | heat shock protein 86 | heat shock protein 86 |
| 5837 | 1363 | S43408 | Meprin 1 alpha | Meprin 1 alpha |
| 25064 | 1364 | S45392 | | |
| 25480 | 1365 | S46785 | insulin-like growth factor binding protein, acid labile subunit | insulin-like growth factor binding protein, acid labile subunit |
| 25481 | 1366 | S46798 | | |
| 4012 | 1367 | S48325 | cytochrome P450, subfamily 2E, polypeptide 1 | cytochrome P450, subfamily 2E, polypeptide 1 |
| 10886 | 1368 | S49003 | | |
| 5493 | 1369 | S56936 | UDP glycosyltransferase 1 family, polypeptide A6 | UDP glycosyltransferase 1 family, polypeptide A6 |
| 15127 | 1370 | S56937 | (UDP glycosyltransferase 1 family, polypeptide A1, UDP | (UDP glycosyltransferase 1 family, polypeptide A1, UDP glycosyltransferase 1 |
| | | | glycosyltransferase 1 family, polypeptide A6, UDP | family, polypeptide A6, UDP glycosyltransferase 1 family, polypeptide A7, UDP- |
| | | | glycosyltransferase 1 family, polypeptide A7, UDP- | glucuronosyltransferase 1A8) |
| | | | glucuronosyltransferase 1A8) | |
| 14003 | 1374 | S65555 | glutamate cysteine ligase, modifier subunit | glutamate cysteine ligase, modifier subunit |
| 355 | 1375 | S66024 | cAMP responsive element modulator | cAMP responsive element modulator |
| 356 | 1375 | S66024 | cAMP responsive element modulator | cAMP responsive element modulator |
| 16248 | 1376 | S68135 | solute carrier family 2, member 1 | solute carrier family 2, member 1 |
| 15832 | 1377 | S68589 | | |
| 1471 | 1378 | S68809 | S100 calcium binding protein A1 | |
| 18647 | 1379 | S69316 | tumor rejection antigen gp96 | |
| 9224 | 1381 | S70011 | | |
| 25518 | 1381 | S70011 | | |
| 15135 | 1382 | S71021 | ribosomal protein L6 | ribosomal protein L6 |
| 25525 | 1383 | S72505 | glutathione S-transferase, alpha 1 | glutathione S-transferase, alpha 1 |
| 18990 | 1384 | S72506 | | |
| 16211 | 1386 | S75960 | uromodulin | uromodulin |
| 1943 | 1388 | S77494 | lysyl oxidase | lysyl oxidase |
| 21583 | 1389 | S77900 | | |
| 25545 | 1389 | S77900 | | |
| 25546 | 1390 | S78154 | | |
| 10260 | 1393 | S81497 | lipase A, lysosomal acid | lipase A, lysosomal acid |
| 25563 | 1393 | S81497 | lipase A, lysosomal acid | lipase A, lysosomal acid |
| 14121 | 1394 | S82383 | tropomyosin isoform 6 | tropomyosin isoform 6 |
| 3609 | 1395 | S82579 | histamine N-methyltransferase | histamine N-methyltransferase |
| 25069 | 1396 | S82820 | | |
| 25070 | 1397 | S83279 | peroxisomal multifunctional enzyme type II | peroxisomal multifunctional enzyme type II |
| 18005 | 1401 | U02320 | neuregulin 1 | neuregulin 1 |
| 20885 | 1403 | U04842 | epidermal growth factor | epidermal growth factor |
| 23606 | 1406 | U05784 | microtubule-associated proteins 1A/1B light chain 3 | microtubule-associated proteins 1A/1B light chain 3 |
| 17806 | 1407 | U06273 | UDP-glucuronosyltransferase | UDP-glucuronosyltransferase |
| 17805 | 1408 | U06274 | UDP-glucuronosyltransferase | UDP-glucuronosyltransferase |
| 24874 | 1410 | U07619 | coagulation factor 3 | coagulation factor 3 |
| 20925 | 1412 | U08976 | enoyl coenzyme A hydratase 1 | enoyl coenzyme A hydratase 1 |
| 20803 | 1413 | U09256 | transketolase | transketolase |
| 646 | 1415 | U10097 | solute carrier family 12, member 3 | solute carrier family 12, member 3 |
| 714 | 1416 | U10279 | solute carrier family 28 (sodium-coupled nucleoside | solute carrier family 28 (sodium-coupled nucleoside transporter), member 1 |
| | | | transporter), member 1 | |
| 1929 | 1418 | U10357 | pyruvate dehydrogenase kinase 2 | pyruvate dehydrogenase kinase 2 |
| 1928 | 1418 | U10357 | pyruvate dehydrogenase kinase 2 | pyruvate dehydrogenase kinase 2 |
| 16268 | 1419 | U10894 | (allograft inflammatory factor 1, balloon angioplasty | (allograft inflammatory factor 1, balloon angioplasty responsive transcript) |
| | | | responsive transcript) | |
| 24900 | 1420 | U12973 | X transporter protein 2 | X transporter protein 2 |
| 1424 | 1423 | U14746 | von Hippel-Lindau syndrome homolog | von Hippel-Lindau syndrome homolog |
| 16675 | 1425 | U17565 | mini chromosome maintenance deficient 6 (S. cerevisiae) | mini chromosome maintenance deficient 6 (S. cerevisiae) |
| 16871 | 1428 | U18314 | thymopoietin | thymopoietin |
| 22196 | 1433 | U21719 | | Rattus norvegicus clone D920 intestinal epithelium proliferating cell-associated |
| | | | | mRNA sequence |
| 133 | 1436 | U24174 | cyclin-dependent kinase inhibitor 1A | cyclin-dependent kinase inhibitor 1A |
| 1537 | 1441 | U27518 | UDP-glucuronosyltransferase | UDP-glucuronosyltransferase |
| 1558 | 1442 | U28504 | solute carrier family 17 vesicular glutamate transporter), | solute carrier family 17 vesicular glutamate transporter), member 1 |
| | | | member 1 | |
| 1559 | 1442 | U28504 | solute carrier family 17 vesicular glutamate transporter), | solute carrier family 17 vesicular glutamate transporter), member 1 |
| | | | member 1 | |
| 20780 | 1444 | U29881 | low affinity Na-dependent glucose transporter (SGLT2) | low affinity Na-dependent glucose transporter (SGLT2) |
| 1598 | 1445 | U30186 | DNA-damage inducible transcript 3 | DNA-damage inducible transcript 3 |
| 1970 | 1446 | U31463 | myosin, heavy polypeptide 9 | myosin, heavy polypeptide 9 |
| 1479 | 1447 | U32314 | Pyruvate carboxylase | Pyruvate carboxylase |
| 23826 | 1451 | U38180 | solute carrier family 19, member 1 | solute carrier family 19, member 1 |
| 797 | 1452 | U38253 | eukaryotic translation initiation factor 2B, subunit 3 | eukaryotic translation initiation factor 2B, subunit 3 (gamma, 58 kD) |
| | | | (gamma, 58 kD) | |
| 19543 | 1455 | U44948 | cysteine rich protein 2 | cysteine rich protein 2 |
| 16147 | 1459 | U51898 | phospholipase A2, group VI | phospholipase A2, group VI |
| 12014 | 1462 | U54632 | Ubiquitin conjugating enzyme E2I | Ubiquitin conjugating enzyme E2I |
| 989 | 1464 | U56242 | v-maf musculoaponeurotic fibrosarcoma (avian) oncogene | v-maf musculoaponeurotic fibrosarcoma (avian) oncogene homolog (c-maf) |
| | | | homolog (c-maf) | |
| 16708 | 1465 | U57042 | adenosine kinase | adenosine kinase |
| 912 | 1468 | U59184 | bcl2-associated X protein | bcl2-associated X protein |
| 15174 | 1469 | U59809 | insulin-like growth factor 2 receptor | insulin-like growth factor 2 receptor |
| 20772 | 1470 | U60882 | heterogeneous nuclear ribonucleoproteins | heterogeneous nuclear ribonucleoproteins methyltransferase-like 2 (S. cerevisiae) |
| | | | methyltransferase-like 2 (S. cerevisiae) | |
| 24643 | 1477 | U68417 | branched chain aminotransferase 2, mitochondrial | branched chain aminotransferase 2, mitochondrial |
| 16398 | 1478 | U75392 | B-cell receptor-associated protein 37 | B-cell receptor-associated protein 37 |
| 25632 | 1481 | U75405 | collagen, type 1, alpha 1 | collagen, type 1, alpha 1 |
| 1602 | 1483 | U76379 | solute carrier family 22, member 1 | solute carrier family 22, member 1 |
| 20887 | 1484 | U76635 | Deoxyribonuclease I | Deoxyribonuclease I |
| 4957 | 1485 | U76714 | solute carrier family 39 (iron-regulated transporter), | solute carrier family 39 (iron-regulated transporter), member 1 |
| | | | member 1 | |
| 25643 | 1486 | U77829 | growth arrest specific 5 | growth arrest specific 5 |
| 23300 | 1488 | U84727 | 2-oxoglutarate carrier | 2-oxoglutarate carrier |
| 1546 | 1489 | U85512 | GTP cyclohydrolase I feedback regulatory protein | GTP cyclohydrolase I feedback regulatory protein |
| 1419 | 1492 | U90887 | arginase 2 | arginase 2 |
| 22675 | 1493 | U92081 | glycoprotein 38 | glycoprotein 38 |
| 17158 | 1496 | V01227 | alpha-tubulin | alpha-tubulin |
| 818 | 1497 | X02291 | aldolase B | aldolase B |
| 20818 | 1498 | X02904 | (glutathione S-transferase, pi 2, glutathione-S-transferase, | (glutathione S-transferase, pi 2, glutathione-S-transferase, pi 1) |
| | | | pi 1) | |
| 33 | 1500 | X03518 | gamma-glutamyl transpeptidase | gamma-glutamyl transpeptidase |
| 20513 | 1503 | X05684 | pyruvate kinase, liver and RBC | pyruvate kinase, liver and RBC |
| 1551 | 1504 | X06150 | Glycine methyltransferase | Glycine methyltransferase |
| 1550 | 1504 | X06150 | Glycine methyltransferase | Glycine methyltransferase |
| 16204 | 1505 | X06423 | ribosomal protein S8 | ribosomal protein S8 |
| 16205 | 1505 | X06423 | ribosomal protein S8 | ribosomal protein S8 |
| 20715 | 1507 | X07259 | cytochrome P450, 4A1 | cytochrome P450, 4A1 |
| 23523 | 1509 | X07944 | ornithine decarboxylase 1 | ornithine decarboxylase 1 |
| 16947 | 1510 | X08056 | Guanidinoacetate methyltransferase | Guanidinoacetate methyltransferase |
| 1853 | 1511 | X12367 | Glutathione peroxidase 1 | |
| 20597 | 1512 | X12459 | arginosuccinate synthetase | arginosuccinate synthetase |
| 20884 | 1513 | X12748 | epidermal growth factor | epidermal growth factor |
| 17377 | 1514 | X13058 | tumor protein p53 | tumor protein p53 |
| 24778 | 1515 | X13119 | serine dehydratase | serine dehydratase |
| 16847 | 1516 | X13549 | ribosomal protein S10 | ribosomal protein S10 |
| 20810 | 1517 | X14181 | | |
| 25675 | 1517 | X14181 | | |
| 15653 | 1518 | X14210 | ribosomal protein S4, X-linked | |
| 25676 | 1519 | X14254 | | |
| 20518 | 1520 | X14265 | calmodulin 3 | calmodulin 3 |
| 19244 | 1521 | X15013 | | |
| 1069 | 1522 | X15096 | acidic ribosomal protein P0 | acidic ribosomal protein P0 |
| 20483 | 1524 | X15939 | myosin heavy chain, polypeptide 7 | myosin heavy chain, polypeptide 7 |
| 21562 | 1525 | X15958 | enoyl Coenzyme A hydratase, short chain 1 | enoyl Coenzyme A hydratase, short chain 1 |
| 3202 | 1527 | X16043 | Protein phosphatase 2 (formerly 2A), catalytic subunit, | Protein phosphatase 2 (formerly 2A), catalytic subunit, alpha isoform |
| | | | alpha isoform | |
| 25682 | 1530 | X16933 | RNA binding protein p45AUF1 | RNA binding protein p45AUF1 |
| 25686 | 1532 | X51536 | ribosomal protein S3 | |
| 23987 | 1533 | X51615 | | |
| 20872 | 1534 | X51707 | ribosomal protein S19 | |
| 9620 | 1535 | X53377 | ribosomal protein S7 | ribosomal protein S7 |
| 20427 | 1536 | X53378 | ribosomal protein S13 | ribosomal protein S13 |
| 25691 | 1537 | X53504 | | |
| 12903 | 1538 | X53517 | CD37 antigen | CD37 antigen |
| 21122 | 1546 | X56228 | thiosulfate sulfurtransferase | thiosulfate sulfurtransferase |
| 21123 | 1546 | X56228 | thiosulfate sulfurtransferase | thiosulfate sulfurtransferase |
| 1885 | 1548 | X56546 | transcription factor 2 | transcription factor 2 |
| 10860 | 1549 | X57133 | hepatocyte nuclear factor 4, alpha | hepatocyte nuclear factor 4, alpha |
| 25699 | 1549 | X57133 | hepatocyte nuclear factor 4, alpha | hepatocyte nuclear factor 4, alpha |
| 10267 | 1550 | X57432 | ribosomal protein S2 | ribosomal protein S2 |
| 1037 | 1551 | X57523 | transporter 1, ATP-binding cassette, sub-family B | transporter 1, ATP-binding cassette, sub-family B (MDR/TAP) |
| | | | (MDR/TAP) | |
| 5667 | 1553 | X58200 | ribosomal protein L23 | |
| 18611 | 1553 | X58200 | ribosomal protein L23 | |
| 17175 | 1554 | X58389 | | |
| 10109 | 1555 | X58465 | ribosomal protein S5 | |
| 25702 | 1555 | X58465 | ribosomal protein S5 | |
| 25707 | 1558 | X59677 | solute carrier family 13, member 2 | solute carrier family 13, member 2 |
| 21651 | 1560 | X60767 | cell division cycle 2 homolog A (S. pombe) | cell division cycle 2 homolog A (S. pombe) |
| 15875 | 1563 | X62145 | ribosomal protein L8 | |
| 4441 | 1564 | X62146 | | |
| 25719 | 1564 | X62146 | | |
| 13646 | 1565 | X62166 | | |
| 18108 | 1566 | X62528 | ribonuclease/angiogenin inhibitor | ribonuclease/angiogenin inhibitor |
| 556 | 1569 | X64336 | Protein C | Protein C |
| 20844 | 1570 | X65228 | | |
| 417 | 1574 | X70141 | | |
| 24640 | 1576 | X70521 | Sodium channel, nonvoltage-gated 1, alpha (epithelial) | Sodium channel, nonvoltage-gated 1, alpha (epithelial) |
| 22219 | 1578 | X72792 | alcohol dehydrogenase 1 | alcohol dehydrogenase 1 |
| 24626 | 1581 | X75856 | Testis enhanced gene transcript | Testis enhanced gene transcript |
| 16272 | 1582 | X76456 | afamin | afamin |
| 24639 | 1584 | X77932 | Sodium channel, nonvoltage-gated 1, beta (epithelial) | Sodium channel, nonvoltage-gated 1, beta (epithelial) |
| 23854 | 1585 | X78327 | ribosomal protein L13 | ribosomal protein L13 |
| 635 | 1586 | X78848 | glutathione S-transferase, alpha 1 | glutathione S-transferase, alpha 1 |
| 13940 | 1587 | X79321 | microtubule-associated protein tau | microtubule-associated protein tau |
| 466 | 1588 | X81395 | carboxylesterase 1 | carboxylesterase 1 |
| 570 | 1590 | X82445 | nuclear distribution gene C homolog (Aspergillus) | nuclear distribution gene C homolog (Aspergillus) |
| 11849 | 1593 | X93352 | ribosomal protein L10a | ribosomal protein L10a |
| 18107 | 1594 | X94242 | ribosomal protein L14 | ribosomal protein L14 |
| 25770 | 1595 | X96437 | | |
| 14347 | 1597 | Y00156 | UDP-glucuronosyltransferase 2B3 precursor, microsomal | UDP-glucuronosyltransferase 2B3 precursor, microsomal |
| 4594 | 1599 | Y07704 | Best5 protein | Best5 protein |
| 20173 | 1605 | Z11932 | arginine vasopressin receptor 2 | arginine vasopressin receptor 2 |
| 407 | 1606 | Z11995 | low density lipoprotein receptor-related protein associated | low density lipoprotein receptor-related protein associated protein 1 |
| | | | protein 1 | |
| 439 | 1609 | Z22607 | Bone morphogenetic protein 4 | Bone morphogenetic protein 4 |
| 8663 | 1611 | Z27118 | heat shock 70 kD protein 1A | heat shock 70 kD protein 1A |
| 17227 | 1612 | Z36980 | D-dopachrome tautomerase | D-dopachrome tautomerase |
| 17226 | 1612 | Z36980 | D-dopachrome tautomerase | D-dopachrome tautomerase |
| 1542 | 1614 | Z50144 | kynurenine aminotransferase 2 | kynurenine aminotransferase 2 |
| 8664 | 1615 | Z75029 | | R. norvegicus hsp70.2 mRNA for heat shock protein 70 |
| 15569 | 1616 | Z78279 | collagen, type 1, alpha 1 | collagen, type 1, alpha 1 |

TABLE 2

| GLGC Identifier | PLS_Score |
|---|---|
| 25024 | −0.03408754 |
| 21011 | 0.005158207 |
| 8317 | 0.00286913 |
| 15861 | 0.01758436 |
| 15862 | 0.01155703 |
| 15028 | −0.04786289 |
| 15154 | 0.01881327 |
| 15296 | 0.00676223 |
| 16518 | 0.02598835 |
| 17764 | −0.02342505 |
| 20711 | −0.01317801 |
| 23778 | 0.002304377 |
| 20795 | 0.00146821 |
| 20817 | 0.0314257 |
| 20833 | −0.004259089 |
| 20919 | −0.0198629 |
| 20920 | −0.007400703 |
| 21012 | −0.003223273 |
| 22351 | −0.008960611 |
| 15848 | −0.01718595 |
| 15849 | −0.04416249 |
| 15850 | −0.01030871 |
| 23837 | −0.0118801 |
| 4312 | 0.003691487 |
| 20864 | 0.007678122 |
| 10241 | 0.01076413 |
| 11434 | 0.06352768 |
| 20801 | −0.01583562 |
| 15126 | −0.002417698 |
| 15297 | −0.006103148 |
| 15124 | 0.01198701 |
| 16080 | 0.02010419 |
| 21013 | −0.001557214 |
| 13479 | −0.03089779 |
| 13480 | 0.003500852 |
| 6780 | −0.003917337 |
| 18989 | 0.000967733 |
| 1475 | 0.01773045 |
| 1321 | −0.03506051 |
| 11955 | 0.02492273 |
| 1920 | 0.01128843 |
| 15189 | −0.005276864 |
| 17765 | −0.02927309 |
| 4010 | 0.0263635 |
| 23225 | 0.01153367 |
| 11956 | −0.009530467 |
| 11755 | −0.03076732 |
| 20713 | 0.02154138 |
| 25057 | 0.01553224 |
| 17378 | −0.008536189 |
| 14956 | 0.00635737 |
| 14957 | −0.008478985 |
| 16468 | 0.01178596 |
| 5733 | 0.01442401 |
| 4748 | 0.00604811 |
| 4749 | −0.001180088 |
| 17758 | −0.01322739 |
| 1301 | −0.03655559 |
| 15125 | −0.005030922 |
| 17541 | 0.01180132 |
| 6406 | 0.008492458 |
| 1598 | 0.03642105 |
| 17805 | −0.01636465 |
| 1537 | −0.02368897 |
| 16768 | 0.005025752 |
| 17158 | −0.006618596 |
| 1037 | −0.03482728 |
| 17377 | 0.009030169 |
| 8664 | 0.005364025 |
| 15569 | −0.01163379 |
| 15408 | −0.004117654 |
| 15409 | 0.02009719 |
| 4615 | −0.0216485 |
| 16148 | −0.007715343 |
| 21078 | −0.002250057 |
| 23109 | 0.005140497 |
| 25064 | −0.02576101 |
| 1466 | −0.0115101 |
| 15741 | 0.001858723 |
| 13723 | −0.03098842 |
| 1183 | 0.007847724 |
| 1174 | −0.02682282 |
| 1814 | −0.02409571 |
| 23445 | 0.01268358 |
| 25069 | −0.01803054 |
| 25070 | −0.001117053 |
| 1247 | 0.002905345 |
| 17301 | 0.02169327 |
| 14346 | 0.01814763 |
| 15017 | −0.005796293 |
| 634 | 0.02392324 |
| 17806 | −0.03059827 |
| 15174 | 0.02558445 |
| 20887 | 0.003184597 |
| 20818 | 0.03540093 |
| 33 | 0.000687164 |
| 23523 | 0.04827108 |
| 1853 | 0.000184702 |
| 23987 | −0.009158069 |
| 21651 | −0.01072442 |
| 635 | 0.01430005 |
| 14347 | 0.007348958 |
| 25098 | 0.01413377 |
| 17157 | 0.002967211 |
| 17337 | 0.03499423 |
| 15703 | 0.003194804 |
| 15662 | −0.01996508 |
| 13973 | 0.01031566 |
| 18075 | 0.001804553 |
| 18076 | 0.01474427 |
| 4234 | −0.03231172 |
| 23625 | 0.008422249 |
| 15243 | −0.009537201 |
| 25165 | 0.004905388 |
| 3454 | −0.01269925 |
| 23045 | −0.01042821 |
| 17326 | −0.01356372 |
| 17327 | −0.01550095 |
| 22603 | 0.01994649 |
| 117 | −0.01073836 |
| 16649 | −0.003848922 |
| 985 | −0.004571139 |
| 4011 | 0.02594932 |
| 16007 | −0.03245922 |
| 16155 | −0.03767058 |
| 25198 | −0.04053008 |
| 744 | 0.01448024 |
| 5496 | −1.62254E−05 |
| 5497 | −0.004547023 |
| 25204 | 0.01864999 |
| 17535 | 0.01886001 |
| 16156 | −0.01055435 |
| 4723 | −0.02257333 |
| 2367 | 0.00281055 |
| 2368 | 0.0198073 |
| 6554 | −0.01628744 |
| 12422 | −0.003597185 |
| 12423 | −0.01363361 |
| 25247 | 0.02928529 |
| 20404 | −0.003382577 |
| 18956 | −0.03746372 |
| 2554 | 0.001275564 |
| 3254 | −0.02432042 |
| 4003 | −0.01871112 |
| 25257 | −0.006161937 |
| 15281 | −0.02035118 |
| 1214 | 0.01756383 |
| 18727 | −0.01572102 |
| 18246 | 0.001154571 |
| 18452 | −0.01337099 |
| 18453 | −0.007857254 |
| 20493 | 0.01936436 |
| 5492 | −0.01191286 |
| 18028 | −0.03629819 |
| 1354 | 0.009908063 |
| 25290 | 0.02397325 |
| 20494 | −0.000954101 |
| 18750 | −0.02634051 |
| 25315 | −0.03588133 |
| 3987 | 0.009837479 |
| 20149 | −0.04258657 |
| 22412 | −0.004335643 |
| 22413 | −0.00221225 |
| 109 | −0.005122522 |
| 22411 | 0.01450058 |
| 455 | −0.01210526 |
| 25405 | 0.01309029 |
| 20298 | −0.05332408 |
| 1622 | −0.003529147 |
| 21882 | 0.006960723 |
| 7872 | −0.01691339 |
| 24615 | −0.003635782 |
| 25460 | −0.007971963 |
| 25467 | −0.002433017 |
| 25468 | 0.009742874 |
| 25469 | −0.01432337 |
| 16449 | −0.000927568 |
| 16450 | 0.004114473 |
| 5837 | −0.005018729 |
| 25480 | 0.006534462 |
| 25481 | 0.03633816 |
| 4012 | 0.02058364 |
| 10886 | −0.02500923 |
| 5493 | −0.00559364 |
| 15127 | 0.01913647 |
| 14003 | 0.00302135 |
| 355 | 0.001723895 |
| 356 | −0.01191485 |
| 16248 | 0.02829451 |
| 15832 | −0.003373712 |
| 1471 | −0.007821926 |
| 18647 | −0.00834588 |
| 25518 | −0.01890072 |
| 9224 | −0.009229792 |
| 15135 | 0.03026445 |
| 25525 | 0.01468858 |
| 18990 | 0.002379164 |
| 16211 | −0.01861134 |
| 1943 | 0.01443373 |
| 25545 | −0.02041409 |
| 21583 | −0.000591347 |
| 25546 | −0.006230616 |
| 10260 | −0.002039004 |
| 25563 | −0.009749564 |
| 14121 | −0.01940992 |
| 3609 | 0.0020902 |
| 18005 | −0.000341325 |
| 16268 | −0.05654464 |
| 22196 | 0.01060633 |
| 12014 | 0.006231096 |
| 16708 | 0.01482556 |
| 16398 | 0.006464105 |
| 25632 | 0.03466999 |
| 4957 | 0.008092677 |
| 25643 | −0.03402377 |
| 23300 | 0.03958223 |
| 1546 | 0.01170207 |
| 22675 | −0.008282468 |
| 818 | −0.01053171 |
| 1550 | 0.01494726 |
| 1551 | 0.02599436 |
| 20715 | 0.01030098 |
| 16947 | 0.02858744 |
| 20884 | −0.02730658 |
| 24778 | −0.02842167 |
| 25675 | −0.0203886 |
| 20810 | −0.02795083 |
| 15653 | −0.00909295 |
| 25676 | −0.04245567 |
| 19244 | 0.01925244 |
| 1069 | 0.02009015 |
| 3202 | 0.01047109 |
| 25682 | −0.03644181 |
| 25686 | 0.01175157 |
| 20872 | 0.005200382 |
| 15201 | 0.01743058 |
| 9620 | 0.009678062 |
| 20427 | −0.007203343 |
| 25691 | −0.01287446 |
| 25699 | −0.01975985 |
| 10860 | −0.01890404 |
| 10267 | −0.01660402 |
| 5667 | 0.003279787 |
| 18611 | −0.01685318 |
| 17175 | 0.008473313 |
| 25702 | 0.006244145 |
| 10109 | 0.005310704 |
| 25707 | 0.03233485 |
| 15875 | 0.002634939 |
| 25719 | −0.01698852 |
| 4441 | 0.01366032 |
| 13646 | 0.01512804 |
| 23708 | 0.000573755 |
| 20844 | −0.00279304 |
| 22219 | 0.003093927 |
| 16272 | −0.004407614 |
| 25770 | −0.01879616 |
| 20173 | −0.007049952 |
| 407 | 0.004526638 |
| 8663 | 0.01127171 |
| 19824 | 1.61079E−05 |
| 1921 | 0.006592317 |
| 24428 | 0.01721819 |
| 24438 | −0.00262423 |
| 18619 | 0.005152837 |
| 24496 | −0.03948592 |
| 24567 | −0.01201788 |
| 291 | −0.02495906 |
| 24770 | −0.008714317 |
| 24843 | −0.03153809 |
| 24874 | 0.02920487 |
| 18686 | 0.01941361 |
| 43 | −0.01441405 |
| 133 | 0.04627691 |
| 24590 | −0.01762193 |
| 16675 | 0.03559083 |
| 13682 | 0.003206818 |
| 417 | −0.0215943 |
| 18008 | 0.003835681 |
| 466 | −0.003738717 |
| 24639 | −0.01283457 |
| 556 | −0.004202022 |
| 714 | 0.005186919 |
| 729 | −0.003318912 |
| 770 | 0.01406266 |
| 797 | −0.01683459 |
| 912 | −0.01437363 |
| 1928 | −0.007305755 |
| 1929 | 0.01778287 |
| 16610 | 0.01123602 |
| 24648 | 0.004198686 |
| 1104 | 0.02800208 |
| 1602 | 0.01814398 |
| 8426 | −0.0182353 |
| 1203 | −0.0288901 |
| 617 | −0.008825291 |
| 11692 | 0.02179052 |
| 19997 | 0.002543063 |
| 10071 | −0.01549941 |
| 16676 | 0.0117799 |
| 19952 | 0.004150428 |
| 15379 | −0.02876546 |
| 25907 | 0.03277824 |
| 19002 | −0.01186146 |
| 19943 | 0.000162394 |
| 20082 | 0.02651264 |
| 18078 | 0.000639759 |
| 20839 | −0.000873427 |
| 4259 | 0.01316487 |
| 15385 | 0.01291856 |
| 4242 | 0.01189998 |
| 16435 | −0.000204926 |
| 16849 | 0.02508564 |
| 15022 | 0.02776678 |
| 8888 | 0.01160653 |
| 1867 | −0.00064856 |
| 24329 | −0.03123893 |
| 1729 | −0.03759896 |
| 9541 | −0.03444796 |
| 21696 | 0.009596217 |
| 20812 | 0.0196699 |
| 13938 | −0.01164793 |
| 15434 | −0.006764275 |
| 15097 | 0.001716813 |
| 23362 | −0.0179409 |
| 17473 | −0.01096604 |
| 15616 | 0.001493839 |
| 18713 | 0.01234178 |
| 815 | −0.02093439 |
| 15247 | 0.01110444 |
| 21950 | 0.000306391 |
| 21682 | −0.006126722 |
| 20802 | −0.01220903 |
| 23709 | 0.02399753 |
| 16510 | 0.03670125 |
| 4449 | −0.00546298 |
| 18077 | 0.0171604 |
| 17160 | 0.01415535 |
| 2109 | −0.005310179 |
| 15190 | −0.01250142 |
| 16918 | −0.01725919 |
| 23660 | −0.01086482 |
| 8749 | −0.03118036 |
| 18687 | 0.003382211 |
| 21975 | 0.01300874 |
| 21842 | 0.001369081 |
| 15191 | 0.01105956 |
| 20717 | 0.01063375 |
| 3431 | −0.006921202 |
| 17570 | 0.007088764 |
| 15259 | −0.01822124 |
| 17563 | −0.02220618 |
| 17829 | 0.005354438 |
| 16081 | 0.0205121 |
| 1474 | −0.03084054 |
| 17448 | 0.02467472 |
| 9125 | −0.01139344 |
| 17196 | −0.06969452 |
| 8212 | 0.02652411 |
| 20702 | 0.002678285 |
| 573 | −0.02872789 |
| 409 | −0.007299354 |
| 4574 | −0.02958615 |
| 754 | −0.0157468 |
| 15468 | 0.000192713 |
| 12700 | −0.01010274 |
| 14124 | −0.01342113 |
| 20126 | 0.0146427 |
| 4450 | −0.04028917 |
| 4451 | −0.04007754 |
| 17197 | 0.02424782 |
| 17198 | 0.033739 |
| 16726 | 0.01229342 |
| 23698 | 0.01072602 |
| 23699 | 0.005510382 |
| 1540 | 0.02953147 |
| 19255 | −0.02175437 |
| 19256 | −0.047948 |
| 20405 | 0.02330483 |
| 20885 | −0.003796437 |
| 46 | 0.01204979 |
| 6055 | −0.01505172 |
| 14997 | −0.01111345 |
| 24563 | 0.002454691 |
| 24564 | −0.01268496 |
| 24651 | −0.0234343 |
| 240 | −0.01207596 |
| 10878 | −0.05290645 |
| 17105 | 0.02110802 |
| 1514 | 0.007158728 |
| 15112 | −0.007915743 |
| 24900 | 0.000776591 |
| 9109 | 0.02180698 |
| 1427 | −0.01731983 |
| 16683 | −0.02202782 |
| 3549 | −0.002275369 |
| 23524 | 0.02175325 |
| 19825 | 0.001300221 |
| 18958 | −0.009980402 |
| 20803 | −0.01980488 |
| 16871 | −0.02941303 |
| 12606 | −0.006382196 |
| 1970 | −0.00636348 |
| 23826 | −0.001208646 |
| 20925 | 0.01287874 |
| 20780 | −0.009828659 |
| 16895 | −0.01042923 |
| 1424 | 0.01814117 |
| 20481 | −2.73489E−05 |
| 1542 | 0.01467805 |
| 17226 | 0.04658792 |
| 17227 | 0.03661337 |
| 1479 | −0.02727375 |
| 1558 | 0.001784993 |
| 1559 | −0.00440292 |
| 20753 | 0.000428273 |
| 20865 | −0.02611805 |
| 1306 | 0.01473606 |
| 19543 | 0.01029956 |
| 15872 | 0.006396827 |
| 24640 | 0.02250593 |
| 20597 | −0.0072339 |
| 439 | 0.002488504 |
| 20518 | −0.008984546 |
| 12903 | 0.007889638 |
| 21562 | 0.002491812 |
| 10248 | 0.03579842 |
| 23606 | −0.000202168 |
| 21122 | 0.005247012 |
| 21123 | 0.01623291 |
| 570 | 0.0196455 |
| 16847 | 0.01145459 |
| 16204 | 0.02414009 |
| 16205 | 0.008361849 |
| 23854 | −0.01483347 |
| 24626 | −0.0146705 |
| 1885 | −0.01965638 |
| 13940 | 0.000886116 |
| 18108 | −0.005199345 |
| 646 | −0.05841963 |
| 20513 | 0.02871836 |
| 20483 | 0.002659336 |
| 11849 | 0.01031365 |
| 1977 | 0.000325571 |
| 20772 | 0.01157497 |
| 16448 | −0.01863292 |
| 18107 | 0.0166564 |
| 755 | −0.03462439 |
| 16681 | 0.0152882 |
| 4198 | 0.02822708 |
| 4199 | 0.004798302 |
| 16147 | 0.01038541 |
| 17554 | −0.02472233 |
| 16354 | 0.02817476 |
| 945 | 0.00993543 |
| 989 | −0.01391793 |
| 16407 | −0.000955995 |
| 7914 | 0.000102491 |
| 1419 | −0.04516254 |
| 24885 | 0.01988852 |
| 7064 | −0.005395484 |
| 17149 | 0.02755652 |
| 17150 | 0.3952128 |
| 17393 | −0.005221711 |
| 17394 | −0.00579925 |
| 1508 | −0.0102906 |
| 17284 | −0.007007458 |
| 17285 | 0.0214901 |
| 18501 | 0.02471658 |
| 18502 | −0.03477159 |
| 4589 | −0.000894857 |
| 18597 | 0.005855973 |
| 4594 | −0.01689378 |
| 16444 | 0.02065756 |
| 20809 | −0.02390898 |
| 15411 | 0.01785927 |
| 4467 | 0.01709855 |
| 18070 | 0.01584395 |
| 7488 | −0.02057392 |
| 24643 | −0.001264686 |
| 1509 | 0.00454317 |
| 13005 | −0.006822573 |
| 1894 | −0.00274857 |
| 4254 | −0.01411081 |
| 1762 | −0.01280683 |
| 1763 | −0.003490757 |
| 7784 | 0.002189607 |
| 23961 | −0.005958063 |
| 20868 | −0.01507699 |
| 20869 | −0.009079757 |
| 20699 | 0.00043838 |
| 20700 | −0.004172502 |
| 11153 | −0.02787509 |
| 16948 | −0.003215995 |
| 1678 | 0.000367942 |
| 1976 | 0.01736856 |
| 17502 | 0.01984278 |
| 17661 | −0.008856236 |
| 15580 | −0.02737185 |
| 17411 | −0.004684325 |
| 4178 | 0.00538893 |
| 15150 | −0.007069793 |
| 11852 | −0.000403569 |
| 4809 | −0.03041049 |
| 19067 | −0.007720506 |
| 20582 | −0.04267649 |
| 22374 | −0.01256255 |
| 22927 | −0.03448938 |
| 4222 | −0.0165522 |
| 7090 | −0.02020823 |
| 15927 | 6.41932E−05 |
| 11865 | −0.006393904 |
| 19402 | −0.04323217 |
| 16139 | −0.009440685 |
| 6451 | 0.006511471 |
| 16419 | −0.01146098 |
| 18084 | −0.01723762 |
| 15371 | −0.01097884 |
| 15376 | −0.008551695 |
| 15887 | −0.0465706 |
| 15888 | −0.007077734 |
| 15401 | 0.03108703 |
| 18902 | −0.003807752 |
| 15505 | 0.02092673 |
| 6153 | 0.005509851 |
| 4361 | −0.000569115 |
| 4386 | 0.02562726 |
| 24235 | 0.000464768 |
| 9952 | −0.009126578 |
| 9071 | −0.000939401 |
| 474 | −0.01146703 |
| 9091 | −0.0287723 |
| 17420 | 0.002994313 |
| 11959 | 0.01476976 |
| 17693 | 0.01033417 |
| 17289 | −0.003851629 |
| 17290 | 0.01185756 |
| 20522 | 0.000628409 |
| 20523 | 0.003173917 |
| 17249 | −0.02066336 |
| 16023 | 0.006094849 |
| 17779 | −0.000918023 |
| 1159 | 0.01132209 |
| 17630 | 0.009499276 |
| 13420 | 0.005331431 |
| 14595 | 0.02173968 |
| 16529 | −0.0408304 |
| 4482 | 0.03541986 |
| 4484 | 0.02414248 |
| 18190 | 0.02839109 |
| 17717 | 0.01780007 |
| 9027 | 0.01143368 |
| 13647 | 0.001145029 |
| 820 | −0.02052028 |
| 12016 | 0.004811067 |
| 21695 | 0.005617932 |
| 4499 | 0.00030477 |
| 8599 | 0.01191982 |
| 12275 | 0.004126427 |
| 12276 | 0.006840609 |
| 18274 | 0.000625962 |
| 18275 | −0.006242172 |
| 4512 | 0.01254979 |
| 15876 | 0.0076095 |
| 17500 | −0.02208598 |
| 23783 | −0.003488245 |
| 13542 | −0.001915889 |
| 22539 | 0.006842911 |
| 23322 | −0.002697228 |
| 12848 | −0.01525511 |
| 3853 | 0.02945047 |
| 3439 | −0.01804814 |
| 12020 | 0.01677873 |
| 3870 | 0.007775934 |
| 548 | 0.01829203 |
| 17752 | 0.01777645 |
| 18967 | −0.03837527 |
| 7505 | 0.00383637 |
| 9084 | −0.02018928 |
| 10540 | 0.02506434 |
| 3895 | −0.01868215 |
| 18396 | 0.01085198 |
| 18291 | 0.01498073 |
| 23063 | −0.002563515 |
| 18361 | 0.01949046 |
| 14309 | 0.002836866 |
| 21007 | −0.003881654 |
| 23203 | 0.001480229 |
| 4412 | 0.01905504 |
| 21035 | −0.01397706 |
| 18462 | −0.0280539 |
| 22386 | 0.01780035 |

We claim:

1. A method of predicting at least one toxic effect of a test agent comprising:
(a) providing nucleic acid hybridization data for a plurality of genes from at least one cell or tissue sample exposed to the test agent;
(b) converting the hybridization data from at least one gene to a gene expression measure;
(c) generating a gene regulation score from the gene expression measure for said at least one gene;
(d) generating a sample prediction score for the agent; and
(e) comparing the sample prediction score to a toxicity reference prediction score, thereby predicting at least one toxic effect of the test agent.

2. A method of claim 1, wherein at least one cell or tissue sample is exposed to a test agent vehicle.

3. A method of claim 2, wherein the converting of step (b) comprises normalizing the hybridization data for background hybridization and for test agent vehicle induced expression.

4. A method of claim 2, wherein the gene expression measure is a gene fold-change value.

5. A method of claim 4, wherein the fold-change value is calculated by a log scale linear additive model.

6. A method of claim 5, wherein the log scale linear additive model is a robust multi-array average (RMA).

7. A method of claim 1, wherein the nucleic acid hybridization data has been screened by a quality control process that measures outlier data.

8. A method of claim 1, wherein step (c) comprises dimensional reduction using Partial Least Squares (PLS).

9. A method of claim 1, wherein the sample prediction score is generated with a weighted index score for each gene.

10. A method of 1, wherein the sample prediction score for the agent is generated from the gene regulation score for said at least one gene.

11. A method of claim 10, wherein the sample prediction score for the agent is generated from the gene regulation score for at least about 10 genes.

12. A method of claim 10, wherein the sample prediction score for the agent is generated from the gene regulation score for at least about 50 genes.

13. A method of claim 10, wherein the sample prediction score for the agent is generated from the gene regulation score for at least about 100 genes.

14. A method of claim 1, wherein the toxicity reference prediction score is generated by a method comprising:
(a) providing nucleic acid hybridization data for a plurality of genes from at least one cell or tissue sample exposed to a toxin and at least one cell or tissue sample exposed to the toxin vehicle;
(b) converting the hybridization data from at least one gene to fold-change values;
(c) generating a gene regulation score from the fold-change value for said at least one gene; and
(d) generating a toxicity reference prediction score for the toxin.

15. A method of claim 1, wherein step (a) comprises loading nucleic acid hybridization data to a server via a remote connection.

16. A method of claim 15, wherein the remote connection is over the Internet.

17. A method of claim 1, wherein the toxicity reference prediction score is provided in a database.

18. A method of claim 17, wherein the toxicity reference prediction score is derived from a toxicology model

19. A method of claim 18, wherein the toxicology model is selected from the group consisting of an individual toxin model, a toxin class model, a general toxicology model and a tissue pathology model.

20. A method of claim 1, further comprising:
(f) generating a report comprising information related to the toxic effect.

21. A method of claim 20, wherein the report comprises information related to the mechanism of the toxic effect.

22. A method of claim 20, wherein the report comprises information related to the toxins used to prepare the toxicity reference prediction score.

23. A method of 20, wherein the report comprises information related to at least one similarity between the test agent and a toxin.

24. A method of claim 16, wherein the hybridization data is contained in a plain text file.

25. A method of claim 16, wherein the hybridization data is contained in a CEL file.

26. A method of claim 1, wherein the nucleic acid hybridization data is annotated with information selected from the group consisting of customer data, cell or tissue sample data, hybridization technology data and test agent data.

27. A method of claim 15, wherein step (a) further comprises selecting at least one toxicity model to predict said at least one toxic effect.

28. A method of providing a report comprising a prediction of at least one toxic effect of a test agent comprising:
(a) receiving nucleic acid hybridization data for a plurality of genes from at least one cell or tissue sample exposed to the test agent and at least one cell or tissue sample exposed to the test agent vehicle to a server via a remote link;
(b) converting the hybridization data from at least one gene to robust multi-array average (RMA) fold-change values;
(c) generating a gene regulation score from the RMA fold-change value for said at least one gene;
(d) generating a sample prediction score for the agent;
(e) comparing the sample prediction score to a toxicity reference prediction score; and
(f) providing a report comprising information related to said at least one toxic effect.

29. A method of creating a toxicology model comprising:
(a) providing nucleic acid hybridization data for a plurality of genes from at least one cell or tissue sample exposed to a toxin;
(b) converting the hybridization data from at least one gene to a gene expression measure;
(c) generating a gene regulation score from gene expression measure for said at least one gene;
(d) generating a toxicity reference prediction score for the toxin, thereby creating a toxicology model.

30. A method of claim 29, wherein at least one cell or tissue sample is exposed to a test agent vehicle.

31. A method of claim 29, wherein the converting of step (b) comprises normalizing the hybridization data for background hybridization and for test agent vehicle induced expression.

32. A method of claim 29, wherein the gene expression measure is a gene fold-change value.

33. A method of claim 32, wherein the fold-change value is calculated by a log scale linear additive model.

34. A method of claim 33, wherein the log scale linear additive model is a robust multi-array average (RMA).

35. A method of claim 29, wherein the generating of step (c) comprises dimensional reduction using Partial Least Squares (PLS).

36. A method of claim 29, wherein step (d) comprises the generation of a weighted index score for each gene.

37. A method of claim 29, wherein the toxicity reference prediction score for the toxin is generated from the gene regulation score for said at least one gene.

38. A method of claim 37, wherein the toxicity reference prediction score for the agent is generated from the gene regulation score for at least about 10 genes.

39. A method of claim 37, wherein the toxicity reference prediction score for the agent is generated from the gene regulation score for at least about 50 genes.

40. A method of claim 37, wherein the toxicity reference prediction score for the agent is generated from the gene regulation score for at least about 100 genes.

41. A method of claim 29, wherein the toxicology model is selected from the group consisting of an individual toxin model, a toxin class model, a general toxicology model and a tissue pathology model.

42. A method of claim 29, further comprising validating the model.

43. A method of claim 42, wherein the validation comprises using a cross-validation procedure.

44. A method of claim 43, wherein the cross-validation procedure is a ⅔/⅓ validation procedure.

45. A computer system comprising:
(a) a computer readable medium comprising a toxicity model for predicting toxicity of a test agent, wherein the toxicity model is generated by a method of claim 29; and
(b) software that allows a user to predict at least one toxic effect of a test agent by comparing a sample prediction score to a toxicity reference prediction score in the toxicity model.

46. A computer system of claim 45, wherein the software enables a user to compare quantitative gene expression information obtained from a cell or tissue sample exposed to a test agent to the quantitative gene expression information in the toxicity model to predict whether the test agent is a toxin.

47. A computer system of claim 45, further comprising software that allows a user to transmit from a remote location nucleic acid hybridization data from a cell or tissue sample exposed to a test agent to predict whether the test agent is a toxin.

48. A computer system of claim 45, wherein the nucleic acid hybridization data from the sample may be transmitted via the Internet.

49. A computer system of claim 45, wherein the nucleic acid hybridization data is microarray hybridization data.

50. A computer system of claim 45, wherein the nucleic acid hybridization data is PCR data.

51. A computer system of claim 45, further comprising a data structure comprising at least one toxicity reference prediction score.

52. A computer system of claim 45, wherein the data structure further comprises at least one gene PLS score.

53. A computer system of claim 45, wherein the data structure further comprises at least one gene regulation score.

54. A computer system of claim 45, wherein the data structure further comprises at least one sample prediction score.

55. A computer readable medium comprising a data structure comprising at lest one toxicity reference prediction score and software for accessing said data structure.
